(19) United States
(12) Patent Application Publication
(10) Pub. No.: US 2003/0115345 A1
(43) Pub. Date: Jun. 19, 2003

(54) Methods and apparatus for masking destination addresses to reduce traffic over a communication link

(76) Inventors: Herman Chien, Redmond, WA (US); Kevin Fung, Seattle, WA (US); Liang A. Hong, Redmond, WA (US); Ileana A. Leuca, Bellevue, WA (US); Kamyar Moinzadeh, Renton, WA (US); Keith C. Nichols, Redmond, WA (US); Wen-Ping Ying, Bellevue, WA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/121,091

(22) Filed: Apr. 11, 2002

Related U.S. Application Data
(62) Division of application No. 09/594,109, filed on Jun. 13, 2000.
(60) Provisional application No. 60/140,906, filed on Jun. 23, 1999.

(51) Int. Cl. G06F 15/16

(52) U.S. Cl. 709/229; 709/232

(57) ABSTRACT

One method described includes the steps of monitoring, at a wireless transceiver unit, communications involving address assignment between a dynamic host configuration protocol (DHCP) server and one or more computer devices; storing, at the wireless transceiver unit, at least one computer device identifier corresponding to at least one computer device that was assigned an address by the DHCP server; receiving, at the wireless transceiver unit, traffic from a first computer device of the one or more computer devices; identifying, at the wireless transceiver using the at least one computer device identifier, that the first computer device is one that was assigned an address by the DHCP server; transmitting, from the wireless transceiver unit over a wireless communication link, traffic from the first computer device based on identifying that it was assigned an address by the DHCP server; receiving, at the wireless transceiver unit, traffic from a second computer device of the one or more computer devices; failing to identify, at the wireless transceiver unit using the at least one computer device identifier, that the second computer device is one that was assigned an address by the DHCP server; and inhibiting transmission, from the wireless transceiver unit over the wireless communication link, traffic from the second computer device based on failing to identify that it was assigned an address by the DHCP server.

### RELATED APPLICATION

This application claims the benefit of U.S. Provisional Application No. 60/140,906, filed Jun. 23, 1999 and entitled “Method and Procedure for Transporting TCP/IP Datagrams Over the PWAN to Other Data Networks,” which is incorporated herein in its entirety.

The following application, assigned to the Assignee of the current invention, and being filed concurrently, contains material related to the subject matter of this application, and is incorporated herein by reference:

Attorney Docket: 1999-0340A (STG204) by H. Chien et al., entitled “Reverse Tunneling Methods and Apparatus for Use with Private Computer Networks,” Ser. No. ______, filed ______.

### BACKGROUND OF THE INVENTION

1. Field of the Invention

The present invention relates generally to the fields of computer networks, address assignment within such networks (such as those involving dynamic host configuration protocol (DHCP) servers), and fixed wireless systems.

2. Description of the Related Art

A private computer network, such as one found in a fixed wireless system (FWS), involves the use of a communication link that is shared between multiple computer devices. When the communication link is shared amongst a large number of computer devices, communications might not achieve a maximum high-speed rate since every communication link has a bandwidth that is limited. If the number of computer devices is advantageously maximized for system efficiency, communication issues might arise if nothing is done to enhance the performance of the shared communication link. In a fixed wireless system, the shared communication link is a wireless communication link between many local home networks (each having a wireless transceiver unit) and a wireless base unit. In some cases, bandwidth may be even more limited using a wireless communication link than for a wired communication link. Wired communication links, on the other hand, are burdensome with respect to installation and maintenance, especially in geographic areas with difficult terrain.

Technologies that are related to the present invention include conventional repeaters, bridges, and smart bridges associated with computer networks. A repeater is basically an unintelligent signal amplifier that can be used to extend a local area network (LAN) beyond the range of the normal physical medium. A bridge or transparent bridge basically interconnects and “unifies” separate LAN segments by capturing, checking for errors, storing, and forwarding, from one side of the bridge to the other, all frames received. Some intelligence and electronics are typically required. In addition, some preconfiguration is typically required, especially if the bridge has more than two ports to define what source and destination addresses are mapped from one port to another port. A smart bridge helps to solve the problems associated with preconfiguration. This type of bridge hears what addresses exist on a given port's LAN via snooping of source addresses in traffic on that port's LAN. When the address is a destination of traffic seen on another port, the bridge knows that it must be exercised to get traffic on the other port into the LAN on which the destination address is known to exist.

What are needed are methods and apparatus for reducing traffic over a communication link used by a computer network, such as a computer network in a fixed wireless system. Similarly, what are needed are methods and apparatus for controlling the use of resources in a computer network, such as a computer network in a fixed wireless system.

### SUMMARY OF THE INVENTION

Methods and apparatus for use in reducing traffic over a communication link used by a computer network are described. One method includes the steps of monitoring, at a gateway, communications involving address assignment between an address-assigning computer device and one or more computer devices; storing, at the gateway, at least one computer device identifier corresponding to at least one computer device that was assigned an address by the address-assigning computer device; receiving, at the gateway, traffic associated with a first computer device of the one or more computer devices; identifying, at the gateway using the at least one computer device identifier, that the first computer device is one that was assigned an address by the address-assigning computer device; transmitting, from the gateway over the communication link, traffic associated with the first computer device based on identifying that it was assigned an address by the address-assigning computer device; receiving, at the gateway, traffic associated with a second computer device of the one or more computer devices; failing to identify, at the gateway using the at least one computer device identifier, that the second computer device is one that was assigned an address by the address-assigning computer device; and inhibiting transmission, from the gateway over the communication link, traffic associated with the second computer device based on failing to identify that it was assigned an address by the address-assigning computer device.

Other methods and apparatus for controlling the use of resources in a computer network are also described. A preferred method here involves the steps of receiving, at an address-assigning computer device, an address request from a computer device of a local computer network; reading, at the address-assigning computer device, subscription data associated with the computer device, the subscription data including data indicative of a maximum allowable number of addresses for simultaneous use by the local computer network; and determining, at the address-assigning computer device, whether to assign an address to the computer device based on the maximum allowable number of addresses and an actual number of addresses simultaneously assigned to the local computer network. This method may include the further steps of assigning an address to the computer device if it is determined that the actual number of addresses is less than the maximum allowable number of addresses, and/or declining to assign an address to the computer device if it is determined that the actual number of addresses is equal to the maximum allowable number of addresses.

A computer network involving another aspect of the present invention includes a plurality of gateway devices and a service-providing network including one or more servers. Each gateway device is coupled to one or more computer devices associated with the device. The plurality of gateway devices and the service-providing network are operative to communicate over a communication link. Each gateway device is operative for receiving traffic from a computer device; masking a destination address of the traffic with a mask which allows addressing to the service providing network but disallows direct addressing to computer devices associated with the plurality of gateway devices; and transmitting, over the communication link, traffic addressed to the service providing network. This method includes the further steps of not transmitting, over the communication link, traffic addressed to the computer devices associated with the plurality of gateway devices. Preferably, the computer network is part of a fixed wireless system which includes a wireless base unit coupled to the service providing network and to the plurality of gateway devices via a wireless communication link.

Finally, a method for use in facilitating communication in a computer network involving one or more computer devices coupled to a gateway is also described herein. The method involves monitoring, at the gateway, communications involving address assignment between an address-assigning computer device and a computer device; identifying, from the communications involving the address assignment, a physical address of the computer device and an address that was assigned to the computer device by the address-assigning computer device; and storing, at the gateway, an association between the physical address and the assigned address. The method may include the further steps of receiving, at the gateway, traffic having the same address that was assigned to the computer device; and sending, from the gateway, the traffic to the computer device based on the stored association. In the detailed embodiment, the computer device is a personal computer (PC), the address-assigning computer device is a dynamic host configuration protocol (DHCP) type server, the physical address is a Medium Access Channel (MAC) address, and the address assigned is an IP address. The gateway may be a wireless transceiver of a fixed wireless system.

### BRIEF DESCRIPTION OF THE DRAWINGS

FIG. 1 is an illustrative representation of a private computer network which embodies the present invention;

FIG. 2 is an illustrative representation of another private computer network which embodies the present invention, including a fixed wireless system;

FIG. 3 is a flowchart describing a method for use in reducing traffic over a communication link used by the computer network of FIG. 1 or FIG. 2;

FIG. 4 is a flowchart describing a method for use in controlling the use of resources in the computer network of FIG. 1 or FIG. 2;

FIG. 5 is an illustrative representation of more detailed structure and functionality in the fixed wireless system of FIG. 2;

FIG. 6 is an illustrative representation of more detailed structure and functionality of the local resources of the fixed wireless system of FIG. 2;

FIG. 7 is a flowchart describing a method employed by a remote unit (RU) for Ethernet frame filtering;

FIG. 8 is a flowchart describing a method employed by the RU for airlink frame processing;

FIG. 9 is an illustrative representation of a format of an Address Resolution Protocol (ARP) message used for Internet to Ethernet address resolution;

FIG. 10 is an illustrative representation of a format of an ARP entry;

FIG. 11 is an illustrative representation of a format of an Internet Control Message Protocol (ICMP) echo request and reply;

FIG. 12 is an illustrative representation of a format of an IP datagram header;

FIG. 13 is an illustrative representation of more detailed structure and functionality of a base unit of the fixed wireless system of FIG. 2;

FIG. 14 is an illustrative representation of an IP numbering architecture for use in connection with the fixed wireless system of FIG. 2; and

FIG. 15 is an example of a user address space deployment and migration strategy for use in connection with the fixed wireless system of FIG. 2.

### DETAILED DESCRIPTION OF THE PREFERRED EMBODIMENTS

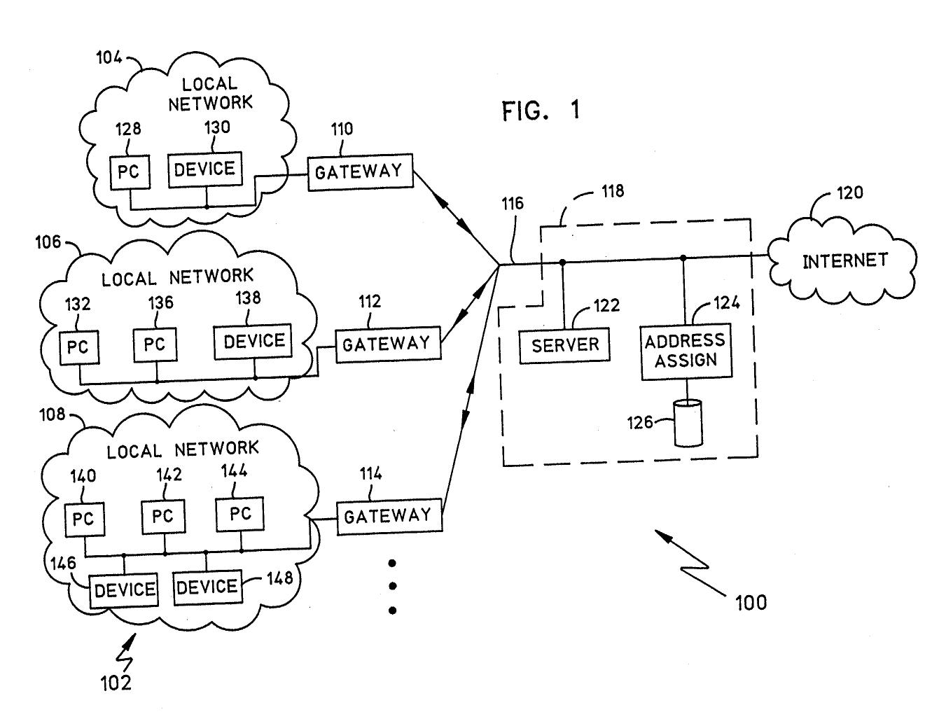

FIG. 1 is an illustrative representation of a private computer network 100 which embodies the present invention. Private computer network 100 includes a plurality of local networks 102, such as local networks 104, 106, and 108. Each one of local networks 102 includes one or more computer devices. For example, local network 104 includes a personal computer (PC) 128 and a computer device 130; local network 106 includes a PC 132, a PC 136, and a computer device 138; and local network 108 includes a PC 140, a PC 142, a PC 144, a computer device 146, and a computer device 148. The PCs have access to the Internet 120. Although shown only as PCs and computer devices, the computer devices may be laptop computers, cordless or cellular telephones, personal digital assistants (PDAs), home appliances, etc.

Each one of local networks 102 is coupled to local resources 118 via a communication link 116. Local resources 118 may be referred to as a service-providing site. A gateway device 110-114 is provided between each one of local networks 102 and communication link 116. Each one of the gateway devices is operative to receive traffic from its associated local network, and either transmit or inhibit transmission of such traffic over communication link 116. In the preferred embodiment, communication link 116 is a wireless communication link and the gateways include wireless transceivers.

As shown in FIG. 1, local resources 118 include one or more servers 122, which may include database servers, Web servers, etc. Local resources 118 also include an address-assigning computer device 124 having access to one or more databases 126. Database 126 includes a pool of private addresses for dynamic assignment to computer devices of local networks 102. In addition, database 126 includes a plurality of subscription data associated with local networks 102. More particularly, each one of local networks 102 has its own subscription data that describes features and/or restrictions associated with its use of private computer network 100. One restriction in the subscription data for each local network includes data indicative of a maximum allowable number of addresses for simultaneous use by the local network. This information is used by addressing assigning computer device 124 to assign or prohibit assignment of addresses to PCs in local networks 102.

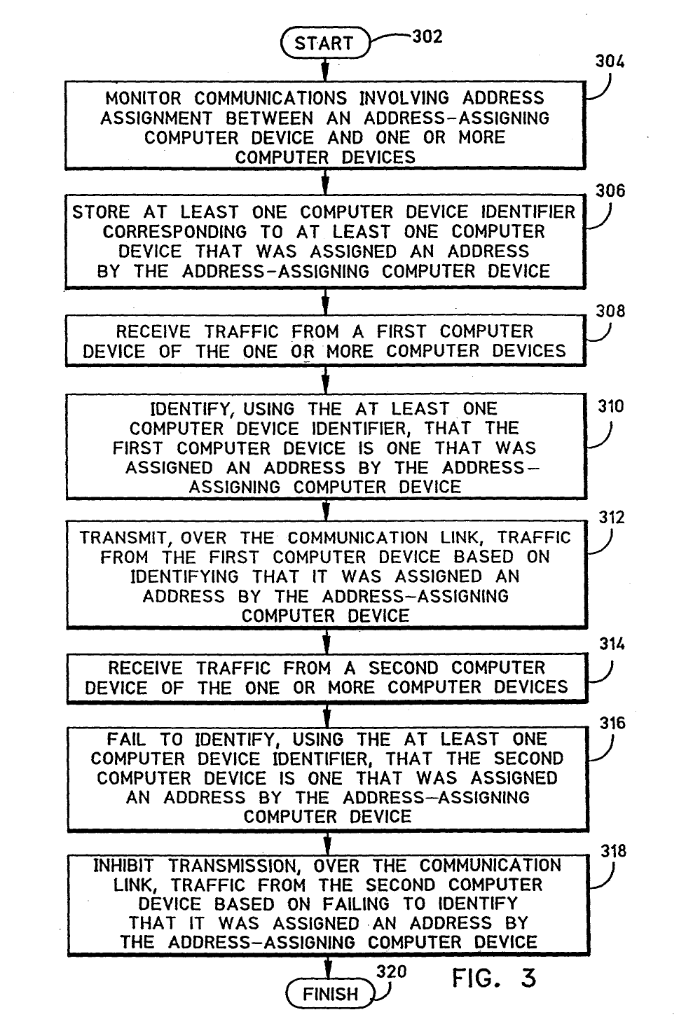

Referring ahead to FIG. 3, a flowchart describing a method for use in reducing traffic over a communication link used by a computer network is shown. Beginning at a start block 302, a gateway device monitors communications involving address assignment between an address-assigning computer device and the computer devices (step 304). The gateway device stores computer device identifiers corresponding to computer devices that were assigned addresses by the address-assigning computer device (step 306). The following steps are repeatedly performed by the gateway device at substantially the same time as the previously described steps 304 and 306. The gateway device receives traffic from a first computer device of the computer devices (step 308) and identifies, using the computer device identifiers, that the first computer device is one that was assigned an address by the address-assigning computer device (step 310). The first computer device may be, for example, PC 132 of FIG. 1. The gateway device transmits, over the communication link, traffic from the first computer device based on identifying that it was assigned an address by the address-assigning computer device (step 312).

On the other hand, the gateway device receives traffic from a second computer device of the computer devices (step 314) and fails to identify, using the computer device identifiers, that the second computer device is one that was assigned an address by the address-assigning computer device (step 316). The second computer device may be, for example, computer device 138 of FIG. 1, which may be a printer, scanner, etc. The gateway device inhibits transmission, over the communication link, traffic from the second computer device based on failing to identify that it was assigned an address by the address-assigning computer device (step 318).

Each computer device identifier stored and utilized by the gateway device may be, as examples, the physical address of the computer device (e.g., its MAC address), or the private address that was actually assigned to the computer device by the address-assigning computer device (e.g., its private IP address). The stored address is compared to a source address in the communication traffic. The communication link may be, for example, a wireless communication link. The address-assigning computer device may be, for example, a DHCP server.

As described, a gateway device may monitor source addresses of communication traffic to allow or prohibit that traffic from being broadcast over the communication link. Preferably, the gateway device monitors destination addresses of the communication traffic as well. In one preferred method, the gateway device disallows direct communication from one local network (e.g., local network 106 of FIG. 1) to all other local networks (e.g., local network 108 of FIG. 1). This is done, for example, by employing a routing filter at the gateway device configured in accordance with the addresses assigned for use in local resources 118, passing only that traffic destined to addresses in local resources 118.

Each gateway device may monitor communications involving address assignment for additional advantageous reasons. In another method, the gateway device identifies communications involving address assignment and stores, in memory, a mapping between each physical address (e.g., MAC address) of each computer device and its assigned address (e.g., private IP address). The physical and IP address relation is contained in one or more messages of such communications. When receiving subsequent traffic for a computer device, the gateway device identifies the destination address, looks up the physical address associated therewith in the stored mapping, and forwards the traffic to the computer device using that physical address. Thus, another benefit from monitoring on the address-assigning exchange is the ability to build an “ARP” table at the gateway device, which allows the gateway device to send IF packets to the computer devices without needing to perform conventional “ARPing” to first identify the corresponding physical address.

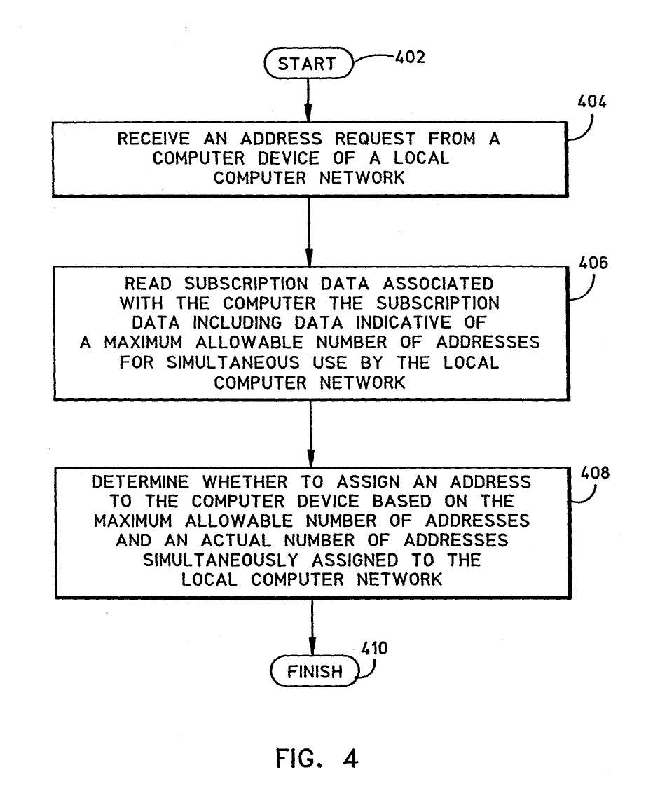

Referring ahead to FIG. 4, a flowchart describing a method for use in controlling the use of resources in a computer network is shown. This method describes an aspect of the communications involving address assignment between the address-assigning computer device and the computer devices, such as those communications described in relation to step 304 in FIG. 3. Beginning at a start block 402, an address-assigning computer device receives an address request from a computer device of a local network (step 404). In response to receiving the request, the address-assigning computer device reads subscription data associated with the computer device (step 406). As described above, the subscription data includes data indicative of a maximum allowable number of addresses for simultaneous use by the local network. The address-assigning computer device determines whether to assign an address to the computer device based on the maximum allowable number of addresses and an actual number of addresses simultaneously assigned to the local network (step 408). The flowchart ends at a finish block 410, but the method may repeat for future requests.

For step 408, the address-assigning computer device assigns an address to a computer device if it is determined that the actual number of addresses is less than the maximum allowable number of addresses. Referring back to FIG. 1, for example, the maximum allowable number of addresses for local network 104 may be one. In this case, if PC 128 requests an address from address-assigning computer device 124, an address should be assigned assuming that no other computer devices in local network 104 have been assigned addresses. On the other hand, the address-assigning computer device declines to assign an address to a computer device if it is determined that the actual number of addresses is equal to the maximum allowable number of addresses in step 408. Referring back to FIG. 1, for example, the maximum allowable number of addresses for local network 108 may be two. In this case, if PC 144 requests an address from address-assigning computer device 124, it should not be assigned an address if computer devices 140 and 142 have already been assigned addresses. This does not necessarily completely prohibit computer device 144 from using local resources 118, since addresses may be de-assigned from computer devices in local network 106 upon, for example, disconnection or power off. For this method, addresses may be dynamically assigned to computer devices or be fixed based on a predetermined relationship between the addresses and physical addresses of the computer devices.

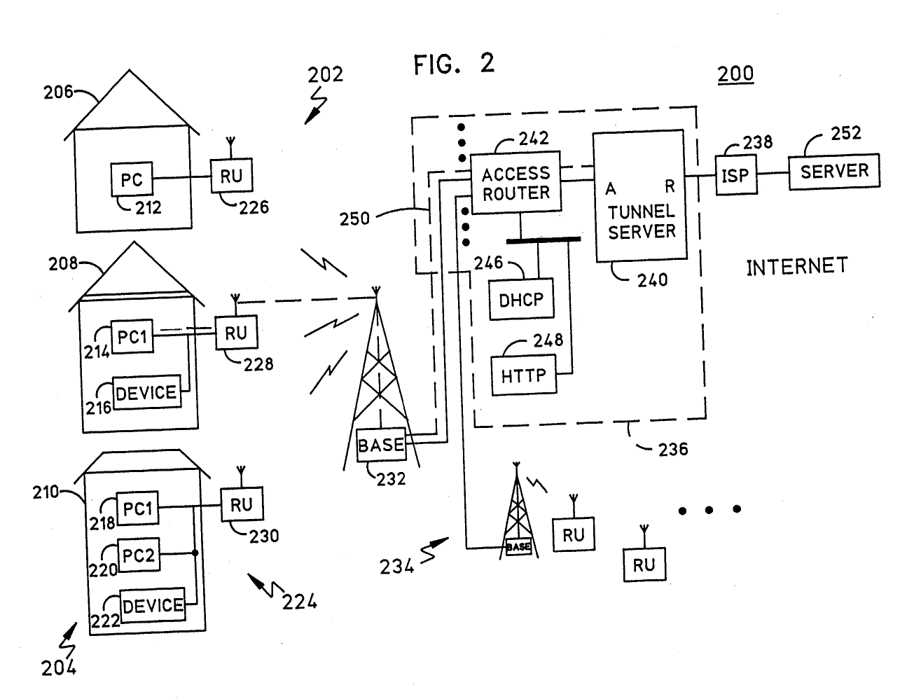

Any suitable maximum number of simultaneous addresses may be indicated in the subscription data for each local network. For example, the maximum could be two addresses, eight addresses, etc. In addition, the subscription for each local network may be unique and have a corresponding cost associated therewith. Thus, resource use in computer network 100 may be advantageously controlled. The methods described in relation to FIGS. 3 and 4 may be employed in connection with FIG. 1, and are even further advantageous in connection with a wireless communication link as described in relation to the fixed wireless system in FIG. 2.

Referring back to FIG. 2, an illustrative representation of a computer system 200 having a private computer network involving a fixed wireless system 202 is shown. Fixed wireless system 202 may be referred to as a “Digital Broadband” system. This computer system similarly embodies the present invention as described in relation to FIGS. 1, 3, and 4. Fixed wireless system 202 involves a plurality of residences 204, including residences 206-210. For example, residence 206 has a computer device 212; residence 208 has a computer device 214 and a computer device 216; and residence 210 has a computer device 218, a computer device 220, and a computer device 222.

Fixed wireless system 202 includes a plurality of remote units (RUs) 224, which are and may be referred to as wireless transceiver units. Each one of residences 204 includes a remote unit; for example, residence 206 has computer device 212 coupled to a remote unit 226, residence 208 has computer devices 214 and 216 coupled to a remote unit 228, and residence 210 has computer devices 218, 220, and 222 coupled to a remote unit 230. Although shown only as PCs and computer devices, the computer devices may be laptop computers, cordless or cellular telephones, personal digital assistants (PDAs), home appliances, etc.

Remote units 224 serve as the gateways as described in relation to FIG. 1. As indicated in FIG. 2, remote units 224 communicate with a base unit 232 via a wireless communication link. A plurality of other base units which serve other remote units are involved as well, such as a base unit 234 and its associated remote units. Base unit 232, as well as other base units such as base unit 234, are coupled to a service node 236 (i.e., local network resources). Service node 236 includes an access router 242, a tunnel server 240, a dynamic host configuration protocol (DHCP) server 246, and a Web server 248. Base unit 232 is more particularly coupled to access router 242, which is in turn coupled to an access port of tunnel server 240. Access router 242 is also coupled to DHCP server 246 and Web server 248. The fixed wireless system, which includes service node 236, is a private network that utilizes private IP addresses.

DHCP server 246 is one type of address-assigning device. DHCP server 246 is operative to dynamically assign private IP addresses as necessary to computer devices within residences 204. The private addresses utilized may include addresses within the range of 10.0.0.0 - 10.255.255.255. Access router 242 is operative to receive IP packets from remote units 224 through base unit 232, and route them to either private resources (e.g., Web server 248) or to public resources (e.g., ISP 238 for the Internet) through tunnel server 240.

Tunnel server 240 may be a conventional Network Access Server (NAS). As indicated, tunnel server 240 has its access port coupled to access router 242 and a resource port coupled to ISP 238. If PC 214 wishes to communicate with server 252 over the Internet, it invokes a request to tunnel server 240. The request is sent through remote unit 228, base unit 232, and access router 242. In response, tunnel server 240 establishes an IP tunnel for communication therebetween. An IP tunnel 250 is represented in FIG. 2 by dashed lines, having terminal points at remote unit 228 and tunnel server 240. For outbound communication (from PC 214 to tunnel server 240 to server 252), tunnel operation for remote unit 228 involves wrapping the appropriate public IP addresses with private IP addresses for communication within the private computer network, and tunnel operation at tunnel server 240 involves unwrapping the public IP addresses from within the private IP addresses for communication to server 252. For inbound communication (from server 252 to tunnel server 240 to remote unit 228), tunnel operation at tunnel server 240 involves wrapping the incoming public IP addresses with the private IP addresses for communication within the private computer network, and tunnel operation for remote unit 228 involves unwrapping the incoming private IP addresses to reveal the underlying public IP addresses. Although some tunnel operations are described as being performed by remote unit 228, these operations may be performed by the PCs as well.

Remote units 224 function as do the gateways of FIG. 1, as described in relation to FIG. 3. Remote unit 228, for example, monitors communications involving address assignment between DHCP server 246 and the computer devices 214 and 216, and stores computer device identifiers corresponding to computer devices that were assigned addresses by DHCP server 246. So, for example, remote unit 228 receives traffic from PC 214 and may identify, using the stored computer device identifiers, that PC 214 is one that was assigned an address by DHCP server 246. Remote unit 228 therefore transmits, over the wireless communication link, traffic from PC 214 based on identifying that it was assigned an address by DHCP server 246. On the other hand, remote unit 228 receives traffic associated with computer device 216, fails to identify that computer device 216 is one that was assigned an address by DHCP server 246, and inhibits transmission of traffic associated with computer device 214 based on failing to identify that it was assigned an address by DHCP server 246.

Preferably, remote unit 228 (as well as the others) monitors destination addresses of the communication traffic as well. More particularly, remote unit 228 disallows direct residence-to-residence communication, i.e., from residence 206 to residences 208 and 210. This is done, for example, by employing a routing filter at the remote unit that is configured in accordance with the addresses assigned for use in service node 236 which passes only that traffic destined to addresses in service node 236.

Remote unit 228 (as well as the others) monitors communications involving address assignment between DHCP server 246 and the computer devices for additional advantageous reasons. Remote unit 228 identifies communications involving address assignment and stores, in memory, a mapping between each physical address (e.g., MAC address) of each computer device and its assigned address (e.g., private IP address). The physical and private address relation is contained in one or more messages of such communications. When receiving subsequent traffic for a computer device, remote unit 228 identifies the destination address, looks up the physical address associated therewith in the stored mapping, and forwards the traffic to the computer device using that physical address. Thus, another benefit from monitoring the DHCP exchange is the ability to build an ARP table at the remote unit, which allows the remote unit to send IP packets to the computer devices without needing to perform conventional ARPing to identify the corresponding MAC address. Because the DHCP exchange identifies the relationship between destination PC IP addresses in the home and the corresponding PC MAC address, a remote unit can forego the implementation of conventional ARP software and look directly to previously observed PC-to-MAC information in the DHCP exchanges to properly set the MAC address of the IP packet heading to the PC.

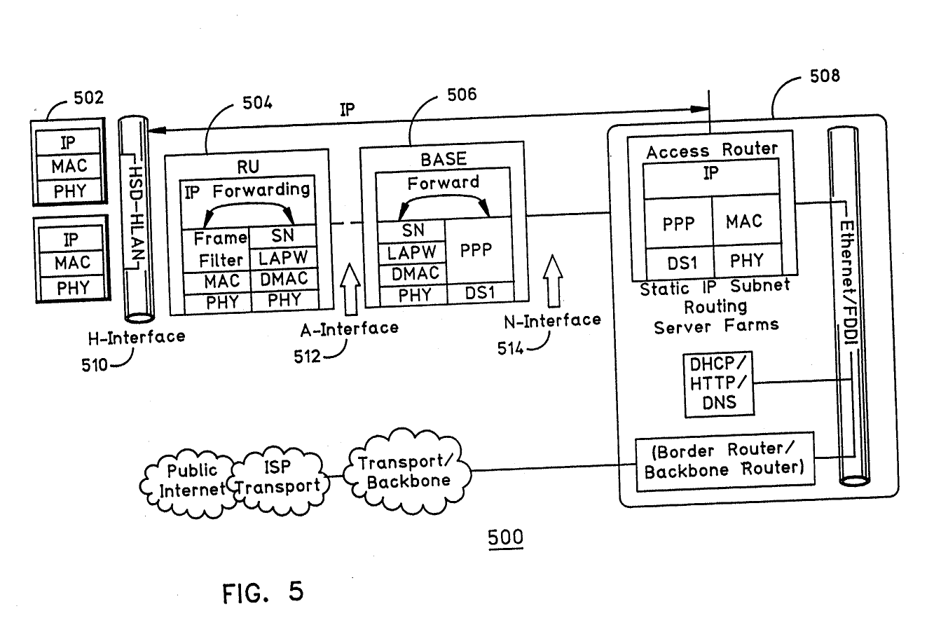

Base unit 232, as well as the other base units in fixed wireless system 202, also utilizes special methods to facilitate proper communication. Base unit 232 communicates traffic to and from multiple computer devices in multiple residences and service node 236. Traffic from remote units 224 is forwarded by base unit 232 (“IP Forwarding” ) to its appropriate address destinations. On the other hand, traffic from service node 236 to the computer devices (“IP Switching”) is handled differently. Base unit 232 has a routing table in memory which maps unique addresses of the computer devices to network addresses (i.e., local network addresses, or residence addresses). Each network address is unique to each network served by base unit 232. Upon receiving traffic destined to one of the computer devices, base unit 232 identifies the network address associated therewith and transmits a broadcast message having the network address. Only the receiver unit associated with that network address receives and forwards traffic associated therewith to its associated computer devices. What is now described are even further details for implementing such a system as one skilled in the art will readily appreciate. FIG. 5 is an illustrative representation of more detailed structure and functionality in the fixed wireless system of FIG. 2. The fixed wireless system (FWS) high speed data (HSD) infrastructure is comprised of four major components and three interfaces that allow the transport of the data from hosts at a user's home to an Internet Service Provider (ISP) of choice for Internet access. The four major components of the HSD infrastructure are a Home Phoneline Networking Alliance (HPNA) Interface Adapter 502 on the PC, a transceiver unit referred to as a remote unit (RU) 504, a base 506, and a data service node (DSN) 508. Connecting these components together are the three interfaces - a Home (H)-interface 510 that connects the PCs to the RU 504; an airlink (A)-interface 512 between RU 504 and base 506; and a Network (N)-interface 514 that links the base 506 to the router on the DSN 508. Although HPNA is preferably used, any suitable home networking technology with an Ethernet appearance which integrates well with the features of DHCP could be utilized. Such technologies follow the Ethernet signaling protocol and MAC/IP addressing formats which allow them to coexist with DHCP advantageously.

The RU 504 serves as the gateway of a home local area network (HLAN) subnet; the base 506 performs the switching function between the RU 504 and the router on the DSN 508. More generally, the RU 504 has three goals to achieve. The first goal is to facilitate the proper communication protocol needed to relay IP packets between the home nodes and the FWS infrastructure. The second goal is to prevent the airlink from carrying superfluous traffic. Lastly, the RU 504 needs to ensure the security of the network.

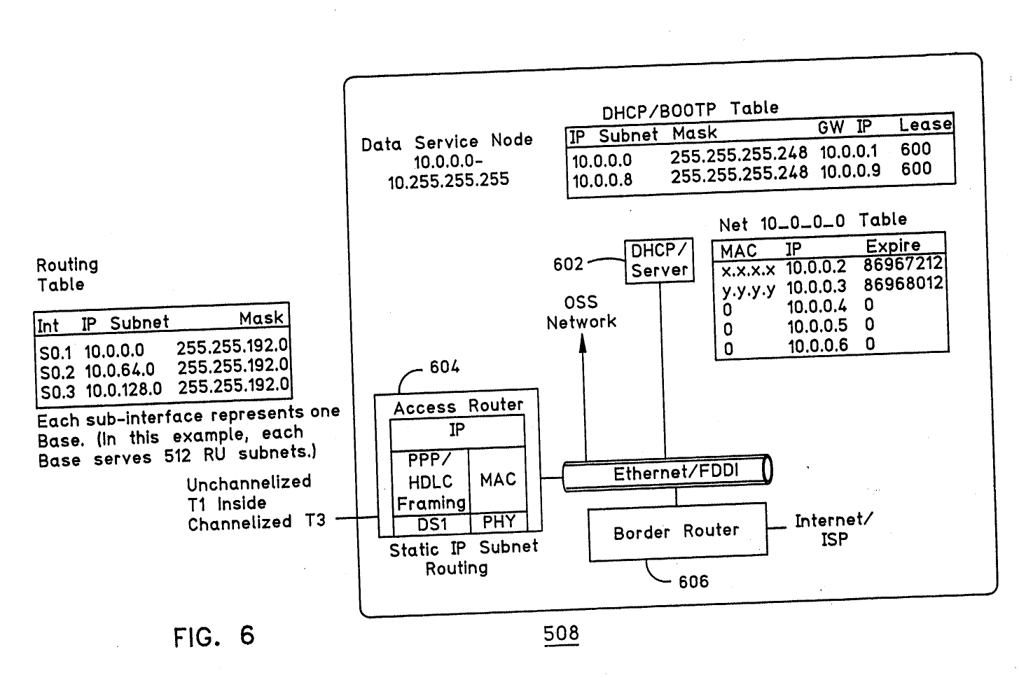

FIG. 6 is an illustrative representation of more detailed structure and functionality of a service site (DSN 508 of FIG. 5) of the fixed wireless system. The DSN 508 connects the HSD infrastructure to the public Internet. It maintains several servers and databases to make the IP infrastructure possible. The DSN 508 contains one router that routes between the base 506 and the interface to the Internet or Internet Service Provider (ISP). The router should have a LAN interface that connects to a DHCP server 602. The router function is split into two parts, an Access Router (AR) 604 that gets traffic from the Bases, and Border Router (BR) 606 that connects to the ISPs. The AR 604 is the interface between DSN 508 and base 506; the BR 606 is the interface between DSN 508 and the ISPs. AR 604 performs the access concentration function and routes the packets to the servers and/or the BR 606 on the DSN 508 whereas the BR 606 performs normal routing and filtering functions to direct the user traffic to/from different ISPs. The DSN 508 should also contain DHCP server 602 to perform IP address and PC configuration management.

In the HSD architecture, the DHCP server 602 assigns the IP address and the local configuration parameters based on the bootstrap protocol (BOOTP) relay agent IP address and the network it is representing. More particularly, if the DHCPDISCOVER message contains a giaddr value (i.e., the client is not on the same LAN segment as the server), the server uses a giaddr value (the IP address) to go over the list of the networks that it is responsible for. If the search fails, it should ignore the request. If the search is successful, it selects an unused IP address along with the configuration parameters for that local network and returns the offer back to the relay agent. The selection of the IP address could be static or dynamic. That is, the association between the MAC address and the IP address could be fixed (static) so that the same PC client always gets the same IP address. Otherwise, the selection is dynamic. Table 1 is an example of part of the DHCP network table on a Solaris 2.6, UNIX system.

TABLE 1
DHCP Network Table

| Name | Type | Value |
|---|---|---|
| angel | m | Include=Locale:Timeserv=10.255.254.2: |
| | | LeaseTim=86400:LeaseNeg:MTU=576: |
| | | Subnet=255.0.0.0:Broadcst=10.255.255.255: |

In this example, what is defined is a profile name “angel” that represents the local configuration parameter. The profile contains information that server includes in the response sent back to the client. In this case, since the subnet mask is 255.0.0.0, the client treats the entire Net 10 as a flat network, including the servers on the DSN 508. The RU acts as a relay agent for DHCP requests. Notice that since the RU proxy-ARPs (Address Resolution Protocol) for the entire HSD infrastructure and the only traffic going out of the HLAN is destined to the infrastructure including the tunnel server, there is no need for the DHCP server 602 to send the Router option back to the client to configure the default gateway. The PC simply sends out the ARP request for the IP address of the server because the address range for the HSD infrastructure, 10.255.254.0/23, is considered on the same physical LAN when the client is configured, with the mask 255.0.0.0.

As apparent, the subnet mask 255.0.0.0 causes the entire 10 net to be viewed as one subnet, with PC's assigned to anywhere in the lower portion of 10 and the servers in the higher portion of 10. This causes the PC to ARP for anything in the 10 network and the RU responds to anything in the 10 net. In another variation, user subnets may be allocated from a point that is somewhere above the lowest possible 10.0.0.0 address. For example, if user subnets were to start by definition from 10.128.0.0 and upward, and with the highest addresses reserved for DSN infrastructure, then the subnet in which the PC's and DSN co-exist can still be viewed as a contiguous block from 10.128.0.0 through 10.255.255.255. That being so, a subnet mask can be assigned by DHCP that is more selective (not inclusive of all addresses down to 10.0.0.0) and causes the PC to ARP for only the addresses in that range, thereby freeing the lower half of the 10 net for other potential uses by the PC or in the home LAN. Thus, the use of other specific settings in the DHCP-assigned settings sent to the PC would result in behaviors familiar to those skilled in the art.

There are also host tables created, one for each HLAN. One typical example on a Solaris implementation is given in Table 2 below. When a DHCP request arrives, the server uses the relay agent IP address to figure out which subnet the request came from. For example, if the giaddr (router IP) is 10.6.1.1, the server uses the subnet mask information from “/etc/netmasks,” which has the value of 255.255.255.248 pre-configured for Net 10. (Note that “/etc/netmasks” is the complete path to the filename in a typical Unix system where the network address masks are typically stored.) In this case, the subnet for the request is 10.6.1.0. The server uses the DHCP Network database with the name ‘10.6.1.0’ for the IP address assignment.

If the DHCP request is for renewal, the source IP address (PC IP) is used along with the netmask to locate the DHCP Network database. For example, if the PC IP is 10.6.1.2, by masking 10.6.1.2 with the subnet mask (255.255.255.248), the server knows that the request comes from the subnet 10.6.1.0; subsequently, the associated DHCP network database is used for extending the lease. An example of the IP address table for network 10.6.1.0 is shown in Table 2.

TABLE 2
DHCP Network Database for Network 10.6.1.0

| Client ID (MAC) | Flags | Client IP | Server IP | Lease | Macro |
|---|---|---|---|---|---|
| 010080C881FB55 | 0 | 10.6.1.2 | 10.255.254.2 | 879835356 | angel |
| 0100C023698087 | 0 | 10.6.1.3 | 10.255.254.2 | 879809556 | angel |
| 0100C02369807B | 0 | 10.6.1.4 | 10.255.254.2 | 881954992 | angel |
| 01080007818B51 | 0 | 10.6.1.5 | 10.255.254.2 | 879365458 | angel |
| 01080307435567 | 0 | 10.6.1.6 | 10.255.254.2 | 879364411 | angel |

Table 2 only shows five usable addresses (the host addresses that have all zeros and all ones are not available). As demonstrated here, the first field of each entry is the MAC address of the device that uses the IP address. The second field defines the use of the IP address. It is a bitmap value where a ‘0’ indicates that the address is available for DHCP allocation, and a ‘3’ indicates that the address is a permanent (no lease expiration) and manual (cannot be assigned) address. The third field indicates the IP address itself. The fourth field shows the IP address of the DHCP server. The fifth field is the lease expiration time stamp (a negative one, −1, means never expires). The last field indicates the profile name for the local configuration parameters to use.

In summary, the DHCP needs the provisioning of the following data: (1) Standard RU subnet tables. Each table contains five IP addresses. The first subnet starts from 10.0.0.0 and ends 10.108.255.248. If the Expanded RU subnet is not used, one can continue the use of the first half from 10.109.0.0 to 10.127.255.248 and extend to the second half of the Net 10 (from 10.128.0.0 to 10.191.255.248). Therefore the total number of standard tables to be provisioned is either 737,280 or 1.5 M. (2) (Optional) Expanded RU subnet tables. Each table contains 13 IP addresses. The subnet starts from 10.128.0.0 and ends 10.223.255.240. The total number of this Expanded subnet to be provisioned is 368,640. (3) Globally, the Subnet Mask, the Broadcast Address, the Lease Time, and the DHCP Server IP Addresses.

Provisional Parameters. Each RU is preconfigured with a HPNA device MAC address (as part of the HPNA chipset setting on the RU). In addition, the RU are provisioned with the RU IP address, the home LAN subnet mask, DHCP Helper IP address, HSD Infrastructure network address, and the HSD network subnet mask. The RU proxies all the requests to the HSD infrastructure servers, represented by the HSD infrastructure network address and its associated mask. In this design, the IP address for the RU is the first IP address from the home LAN subnet. The subnet masks are used by the RU to speed up the ARP table lookup for both the routing (traffic coming from the airlink) and the filtering (traffic coming from the HSD HLAN) purposes.

Ethernet Frame Filtering. The HPNA Ethernet controller on the RU is instructed to deliver only three types of MAC frames to the RU processor—physical (unicast) address frame, group (multicast) address frame, and the broadcast address frame. The physical address is programmed into the HPNA chipset. Multicast address framing recognition and filtering is needed if IP multicast is supported.

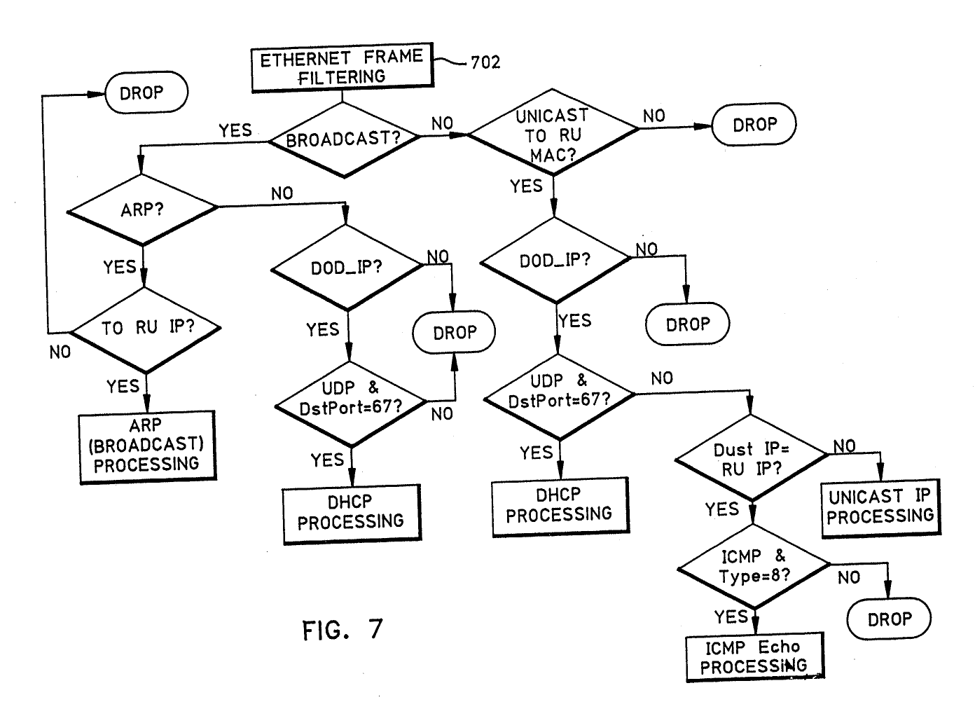

FIG. 7 is a flowchart describing a method that the RU processor executes to perform Ethernet frame filtering for packets arriving from the HLAN. The processing begins at a start block 702, which is labeled “Ethernet Frame Filtering.” (1) If the frame is a broadcast frame, check the EtherType to see if the frame is an ARP request. If the frame is an ARP frame (EtherType 0x0806), proceed to perform ARP (Broadcast) Processing. If the frame is an IP datagram (EtherType 0x0800) of user datagram protocol (UDP) (Prot=17) with Dest Port 67 (BOOTPS), proceed to perform DHCP Processing. Everything else is dropped. (2) If the frame is a unicast frame (RU MAC physical address), check whether it is an IP datagram. If not, drop the frame. If yes, check whether it is UDP with port 67. If yes proceed to perform DHCP Processing (Unicast). If not, check whether the destination IP is the RU IP. If yes, check whether this is an Internet Control Message Protocol (ICMP) message (Prot=1). If it is an ICMP type 8 (echo request) message, perform ICMP Echo Processing. Otherwise, proceed to perform Unicast IP Processing. (3) Multicast frames are not processed and therefore are dropped.

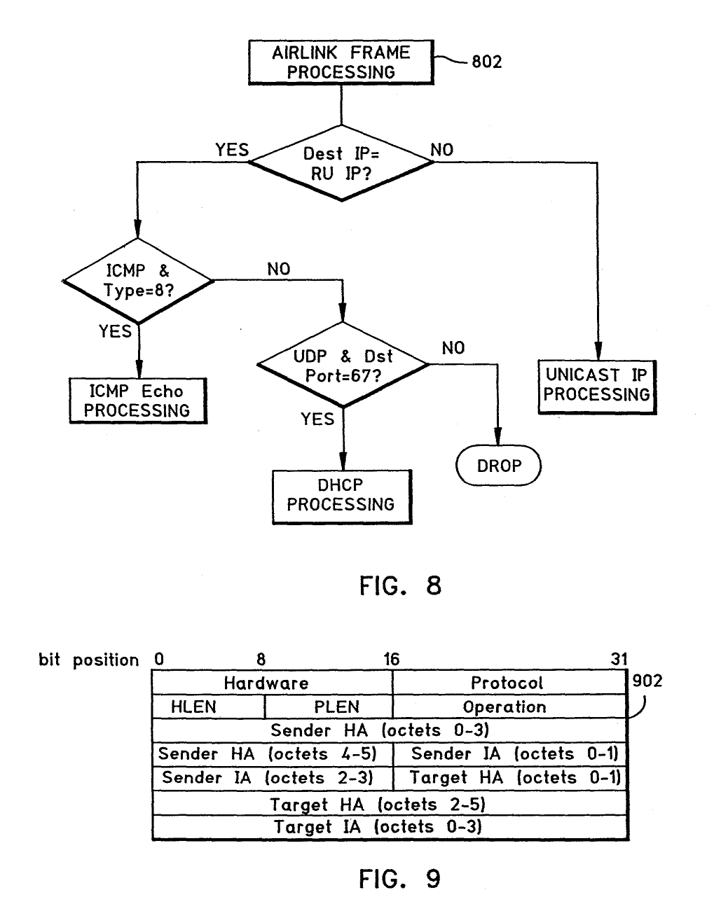

Airlink Packets Filtering. FIG. 8 is a flowchart describing a method that the RU executes to perform airlink packet filtering. IP packets from the airlink side also need the filtering process before the RU relays the packets to the desired PC on the HLAN. The method begins at a start block 802, labeled “Airlink Frame Processing.” (1) RU first checks if the destination IP address matches the RU IP address. If it matches, proceed to Step 2, else proceed to Step 3. (2) Check the type of IP packet. If it is of type ICMP type 8, proceed to perform ICMP Echo Processing. If the type is BOOTP (UDP with destination port 67, BOOTPS), proceed to perform DHCP processing. Everything else is dropped. (3) Proceed to perform Unicast IP Processing for forwarding the IP datagram.

ARP (Broadcast) Processing. ARP is a mechanism used by the network devices to determine the physical (MAC) addresses based on the IP address. This is always sent in the broadcast mode and from the home LAN. FIG. 9 shows the ARP format 902. Field HARDWARE specifies a hardware interface type for which the sender seeks an answer; it is 1 for Ethernet. Field OPERATION specifies an ARP request (1) or an ARP response (2). Fields HLEN and PLEN allow ARP to be used with arbitrary networks since they specify the length of the physical hardware address and the length of the protocol address. In this case, the HLEN is 6 and PLEN is 4. The sender supplies its hardware address and the IP address in fields SENDER HA and SENDER IA. When making a request (OPERATION=1), the sender also supplies the target IP address in TARGET IA field. A response (i.e., OPERATION=2) carries both the target machine's hardware and IP address in TARGET HA and TARGET IA fields.

When the RU sees the ARP request, it checks if the TARGET IA matches its IP (RU IP) address or falls into the HSD infrastructure network range. If it matches one of the conditions, the RU constructs an ARP response by filling in its hardware address in the TARGET HA, swapping the two sender addresses with the two target addresses, setting the OPERATION to 2, and sending the reply out. It also updates the ARP table using the information provided by the ARP request in addition to the learning from observing DHCP activity (described later below). As previously described, this could also be accomplished by applying a suitable mask to identify a desired higher range of infrastructure addresses as one ordinarily skilled in the art will appreciate.

Learning from the ARP allows the user to manually configure a home appliance which does not support DHCP mechanism. This is also needed in case the RU loses the ARP table due to any failures while the PC is still up and running. Otherwise, the RU can only re-acquire the IP address to MAC address mapping by observing the four-phase DHCP activity. Building the ARP entry by learning from the ARP requests from the PCs therefore speeds up recovery process in case of the RU failure, since the normal ARP cache on the PC times out periodically so that the PC always sends out an ARP request to resolve the RU IP address every few minutes. Also note that the information carried in the DHCP negotiation should preempt the learning from the ARP request. DHCP/BOOTP Relay (Broad-/Unicast) Processing—ARP Table Learning. The RU performs the BOOTP Relay Agent function as defined in Request For Comments (RFC)-1542 to allow the BOOTP/DHCP message exchanges between the clients and the server(s) not residing on the same IP subnet. Since the BOOTP relay agent is not simply forwarding the messages—a distinction from the router function—it may be thought to receive BOOTP/DHCP messages as a final destination and then generate new BOOTF/DHCP messages consequently. As an added value to relaying the BOOTP messages, the RU uses the content of the ‘chaddr’ and ‘yiaddr’ fields to create an ARP-table entry in exactly the same way the normal ARP protocol would have. This saves the development of the ARP protocol on the RU to perform the PC IP address to hardware address translation. As described earlier above, the DHCP processes involved in the HSD are limited to the initial client request and the client renewing the request. The following description relates to the process performed by the RU in serving the role as a DHCP relay agent and building the ARP table based on the ‘chaddr’ and ‘yiaddr’ fields learned in relaying the DHCP messages.

DHCP Received From Home LAN. If the message arrives in broadcast mode, insert the RU IP address as the giaddr without altering anything else in the original DHCP message. The RU should reconstruct the UDP by using RU IP as the source IP and DHCP server IP as the destination IP. Both the source and destination ports should be set to 67 (BOOTP Server port). Once the relay message is constructed, the RU forwards it to the airlink stack for further processing. The UDP checksum also needs to be recomputed as specified in RFC-768. If the message arrives in the unicast mode, the IP unicast address must be the DHCP server IP address. The RU is not required to perform such check. Nevertheless, this check may be desirable to filter out erroneous DHCP unicast requests to conserve the airlink resource. The RU should forward every unicast DHCP message to the airlink stack. With respect to “ARP Learning”—if the DHCP message is a DHCPDECLINE message (Message Type 4) or a DHCPRELEASE (Type 7), the RU should remove the corresponding ARP entry from the table and forward the message to the airlink.

DHCP Received From Airlink. If the message is sent to the RU IP address, the RU should change the UDP header so that the source IP is the RU IP and the destination IP is the client IP specified in the yiaddr field. The RU may check the MSB of the flags field to see whether the broadcast flag is set or not. If this flag is set, the destination IP address should be set to 255.255.255.255 (broadcast). (Per RFC-1542, the use of the broadcast should be discouraged, and the RU can ignore the flag and also assume the unicast mode.) The RU then uses the client MAC address contained in the chaddr field to construct the Ethernet header. With respect to ARP learning, the RU should also check whether the message is a DHCPACK message and refresh the ARP table. (To increase the process efficiency, the RU may elect not to check the MsgType option and act upon any DHCP message addressed to the RU. This includes both the DHCPOFFER and DHCPACK messages. Although two ARP updates are done per initial DHCP request, this removes the need for the RU to scan through every DHCP option to locate the MsgType option.) The RU looks up the ARP table based on the yiaddr value. If the entry does not exist already, the RU should create an entry that maps the IP address to the MAC address specified by the chaddrr field. FIG. 10 depicts an ARP entry format 1002 that is preferred. The optional Reserved field can be used for anything from access control to priority treatment in the future. If the entry exists already, the RU updates the ARP entry with the MAC address specified in the current chaddrr field. This is to guarantee that the RU has the up-to-date ARP entry even if the IP address is assigned to a different device when every other mechanism failed (e.g., lease expiration, proper lease release, etc.) If the DHCP message is sent to a PC, the RU would have processed the packet by following the unicast to non-RU address logic. If the ARP entry does not already exist. RU silently discards the message. There is no need for ARP learning in this scenario.

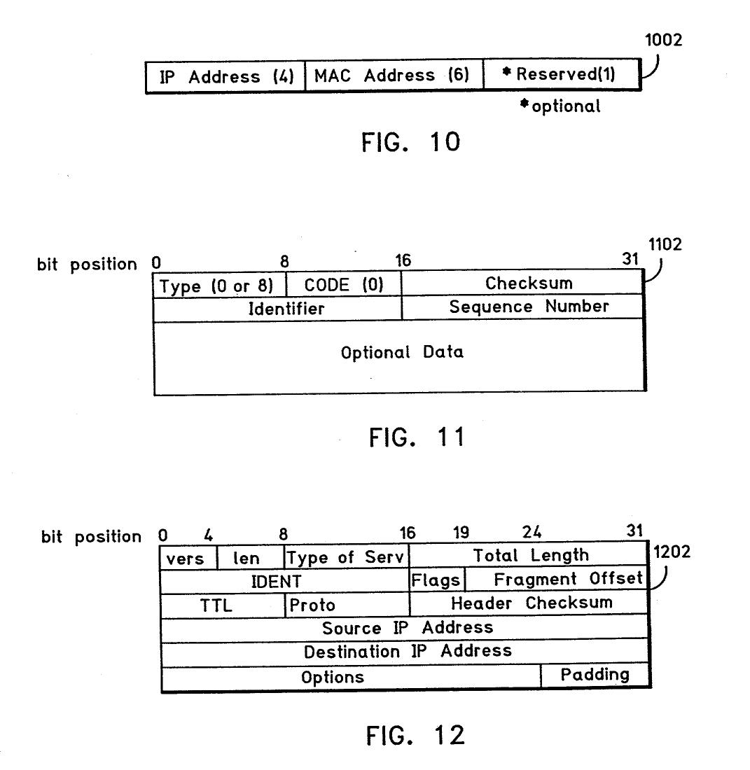

ICMP Echo Request (Unicast) Processing. Since the RU is not required to initiate the ICMP echo-request, every ICMP message destined to an RU (a unicast from either side of the network) must be an ICMP echo-request. That is, the RU should not see any echo-reply as a response to the echo-request; if it does, the RU should silently ignore the ICMP echo-reply messages addressed to its IP address. A format 1102 of ICMP message for echo request and reply is shown in FIG. 11. As described previously, the TYPE field indicates the Echo type, 0 for reply and 8 for request. CHECKSUM is computed the same way as the IP header checksum generation (described below) and it should be computed over the entire ICMP message. When the RU receives an echo request, it performs the ICMP checksum check to verify packet integrity. If the check fails, no reply should be henerated. The IDENTIFIER, the SEQUENCE NUMBER, and the OPTIONAL DATA fields should be copied as is in the reply message.

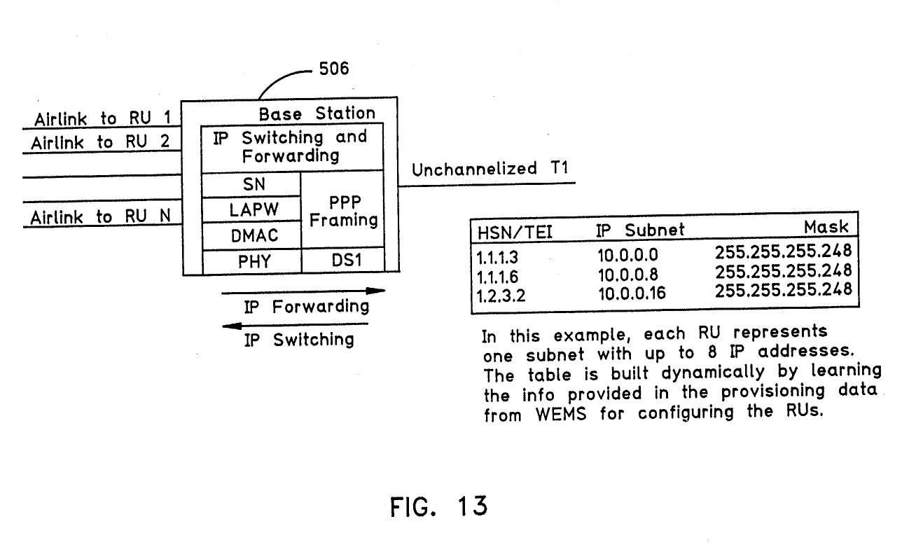

The following is a description of the steps needed to construct an ICMP echo reply. (1) IP header generation (refer to a format 1202 in FIG. 12): the address of the source in an echo message is the destination of the echo reply message. To form an echo reply message, the source and destination addresses in the IP header are simply reversed, the TYPE OF SERV code changed to 0, and the checksum recomputed (2) lCMP reply message generation: TYPE field set to 0 for echo reply, type CODE set to 0, the data received in the echo message must be returned in the echo reply message. These include the Identifier, the Sequence Number, and any optional data included in the original request message (3) ICMP Checksum generation: The checksum is the 16-bit ones complement of the ones complement sum of the ICMP message starting with the ICMP Type. For computing the checksum, the checksum field should be zero. If the total length is odd, the received data is padded with one octet of zeros for computing the checksum.

IP Packet Relay (All Other Unicast) Processing. All the unicast IP packets that are not addressed to the RU itself are filtered based on the IP address in the IP header. For the packets from the HLAN side, the source IP address is used for filtering purposes. The RU only forwards packets to the airlink if the source address falls in the HLAN subnet range. This is the equivalent of the source address filtering. In addition, the destination should fall in the HSD infrastructure subnet range. Otherwise, the packet should be dropped. For the packets from the airlink side, the destination IP address is used for filtering purposes. The RU only forwards the packets to the HLAN when an ARP entry exists for that IP address. The IP packets are framed with the corresponding MAC address obtained from the entry as the destination physical address. This removes the need for performing the ARP function. If the filtering failed, the IP packet should be silently discarded. (There is no need to generate ICMP host-unreachable message. This is compatible with the modem dialup Internet access scenario.)

IP Header Checksum Check. In the design of the TCP/IP protocol suite, the integrity of the IP header was deemed very important since the IP works with any unreliable transport. If the IP header integrity can be validated, the routers can then decide whether the IP has valid header information to further deliver the packet. FIG. 12 shows the IP header format. The length field (LEN) gives the IP datagram header length in 32-bit words. The most common header, without the options, contains 20 octets, and has a length field equal to 5. The IP header checksum is generated by treating the header as a sequence of 16-bit integers (in network byte order), adding them together using one's complement arithmetic, and then taking the one's complement of the result. For purposes of generating the checksum, field HEADER CHECKSUM is assumed to contain zero. At the receiving end, because the calculated checksum also includes the checksum stored in the IP header received, the receiver's checksum should be all one bits if nothing in the header was modified. If the result is not all one bits, it is a checksum error. Both the RU and base perform the IP header checksum check, not only to be compliant to the specification made in the TCP/IP standards, but also for the purpose of an early detection of Cipher key out-of-sync situation.

The following steps describe the procedure on the RU to perform the IP header checking as well as the detection of the cipher key out-of-sync problem. (1) Packets coming from the H-interface (HLAN side) are scrutinized for the correct IP header checksum. If the checksum check fails, drop the packet and process the next packet. If the checksum check is successful, pass the IP packet to the airlink stack for encryption and Link Access Protocol Wireless (LAPW) processing; LAPW is a modified version of LAPB, which is a standard link layer protocol. (2) After airlink stack processing and decryption, packets coming from the A-interface (airlink side) are checked for the correct IP header checksum. If the checksum check is successful, pass the IP packet to the H-interface to continue the proper Ethernet framing and deliver to HLAN. If the checksum check fails, the packet is dropped and the recovery procedure is triggered. The recovery procedure may include re-establishment of the airlink to clear all the buffers and to re-negotiate the cipher keys for encryption.

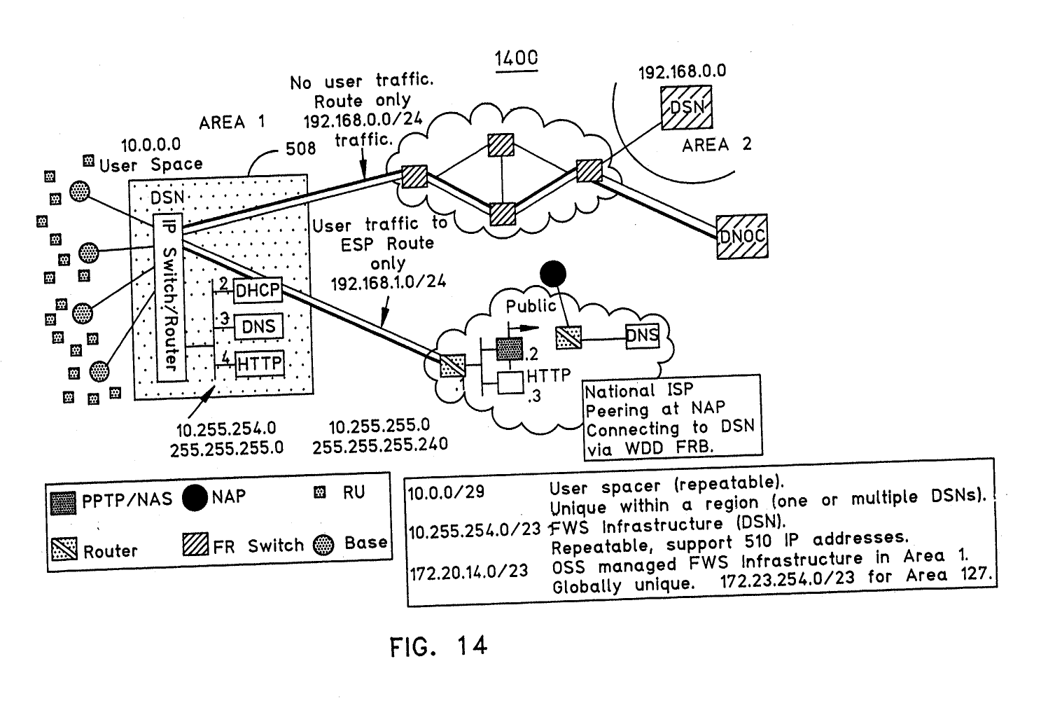

Base Functions. The primary function of the base is to forward the IP packets to the router when the traffic comes from the airlink and to switch the IP packets to the RU in the opposite direction. The switching is based on the routing table that is learned via the provisioning process to provision the RUs via the Base. The following description is provided for the base: an IP forwarding function, followed by an IP switching function, and an IP header checksum check process required to ensure not only the integrity of the IP packets but also the synchronization of the encryption process performed between the RU and the Base. FIG. 13 shows an illustrative representation of base unit 506 of FIG. 5.

IP Forwarding. IP forwarding describes the scenario where the base relays the received IP packets to the next hop without making any routing decisions. This applies to the traffic coming from the airlink side. After recovering the IP packets from the Sub-Network Layer (SNL) of the airlink data stack, the base simply performs the Point-to-Point Protocol (PPP) framing function to encapsulate the IP packets and forwards the PPP frame to the Digital Signal Level 1 (DS1) interface. By performing only the IP forwarding on the traffic coming from the airlink, it dramatically reduces the switching overhead on the Base. This is because the majority of the traffic in this direction flows to the Internet rather than to other PCs served by the same Base. In the case of traffic destined to the PC served by the same Base, those packets are re-routed back to the Base. They are switched to the correct RU that serves the PC using the IP switching capability on the Base. Preferably, however, no traffic can flow directly from PC to PC because of the RU filtering and the DSN AR which prevent such flow. With this feature, PC to PC traffic is only realizable if tunnels are established as described earlier.

IP Switching. The purpose of the base IP switching is to shuffle IP packets from the network side to the RU that serves the intended recipient via the LAPW connection designated by the Terminal Equipment Interface (TEI). This function is identical to the routing function performed by the ordinary router. It is not referred to as “routing” because the base only performs half of the routing (i.e., for one-way) and the algorithm is not the same as the one used by a commercial router. Once the PPP frame arrives at the N-interface, the IP packet (payload of the PPP frame) is recovered and is passed through the process of switching decision. The process maps the destination IP to a TEI and forwards the packet to the associated LAPW connection.

The following discusses the content of the routing table and a scheme to speed up the routing table lookup. The routing table is described first. In order to reduce the complexity of the switching and the route construction processes, the content of the routing table is assumed to be subnet based. That is, the base is operated under the subnet mode when the subnet-based architecture is enforced, and the routing table contains one subnet per route. Each route entry logically may contain the Network IP address, the network mask, and the EI. The routing decision is made by first applying the mask to the destination address of the IP packet and comparing to the network ID. If there is no match, the next entry is used. If a match is found, the TEI is used to further relay the IP packet. Obviously, the search for a right match has to be more efficient in case the number of entries is large. Commercial routers typically employ a scheme that rank-orders the routes and uses a sequential bit-by-bit mapping to determine the match (the RADIX sort algorithm.) This is particularly efficient for a routing table containing both the host and the network entries. In the base development, other schemes may be used because the table contains only network entries. One example is described below. Here, the direct routing table look-up is described. In the case of routing in the subnet mode, one improvement can be made to the linear search described previously by creating a lookup table to store fixed-record route entries, one for each subnet. A description of this table is provided below in connection with the description on route creation. Upon receiving an IP packet from the router, the base follows the steps described below to find a route: (1) Based on the destination IP address (10.0.0.0/9 or 10.128.0.0/9), a proper netmask is used (0.0.31.248 or 0.0.31.240) to obtain the condensed network IP address. (2) Perform the offset into the route table based on the network IP. If the entry pointed by the offset exists, use the TEI to route the packet. (3) If the offset points to an empty entry, the packet is dropped.

IP Header Checksum Check. As described above, both the RU and base need to perform the IP header checksum check to be compliant to the TCP/IP standard and to allow the early detection of the Cipher key out-of-sync situation. The following steps describe the procedure on the base to perform the IP header checking as well as the detection of the cipher key out-of-sync problem. (1) Packets coming from the N-interface (router side) are scrutinized for the correct IP header checksum. If the checksum check fails, the base drops the packet and processes the next packet. If the checksum check is successful, the base passes the IP packet to the airlink stack for the encryption and LAPW processing. (2) Packets coming from the A-interface (airlink side) are also checked for the correct IP header checksum after the proper airlink stack and decryption processing. If the checksum check is successful, the base passes the IP packet to the N-interface to continue the proper PPP framing and delivering to the next hop router. (3) If the checksum check fails, this is the indication of a cipher out-of-sync situation; the packet is dropped and the recovery procedure is triggered. The recovery procedure may include re-establishment of the airlink to clear all the buffers and to re-negotiate the cipher keys for encryption.

Route Creation. As part of the provisioning process, the base is used as the conduit to pass the RU IP address and the associated subnet mask to each RU to which it connects. The base constructs the routing table via this provisioning process. Each subnet route entry is created by performing an AND operation on the RU IP and the subnet mask to obtain the subnetwork address (Network IP) represented by the RU subnet. Each route entry is used to route all the network devices of that subnet including the RU itself, as described above in connection with the routing table.

To speed up the routing lookup, the entire table is cached in the memory. This requires compacting the routing table using a prior knowledge of the subnet mask. The subnet mask is used in two ways. First it is used in the routing table creation in deriving the subnets of the HLANs based on the RU IP addresses. It is then used to derive the network IP based on the incoming IP datagram for routing. Because of the proper IP numbering planning, the subnet mask can be implied based on the IP address range used. Combining with the contiguous assignment of the subnets within the Base, this allows the base to perform a direct table lookup instead of a linear lookup.

The user address space, including the subnet sizes of 8 & 16, uses the private Class A. The subnet 10.0.x.x has a subnet mask of 255.255.255.248; the subnet addresses 10.128.x.x have the mask of 255.255.255.240, if the range is used to support the subnet size of 16. To save the amount of memory needed to store the network routes for all the RUs, the base only reserves the table space for as many entries as the maximal RUs supported by the base. This can be achieved by using a special subnet mask such that the mask-out portion of the Network IP is unique within the base and has a maximal value equal to the number of HSD RUs supported by that base.

Assuming the maximal number of the HSD RUs with subnet of 8 that can be served by the base is 1024, the aggregated subnet for the base has the mask of 255.255.224.0. A special subnet mask for the purpose of routing can now be created by negating the base subnet mask, then ANDing it with the RU subnet mask. This operation results in a special mask that, once ANDed with the IP address, generates a condensed network IP (a number between 0 and 1023) which uniquely identifies the RU served by this Base. For Net 10.0.x.x, this special netmask is 0.0.31.248 (10 ones). Similarly if the number for the subnet of 16 (10.128.x.x) is 512, then the mask for routing is 0.0.31.240 (9 ones).

Once these special masks are derived, the condensed network IP for each RU can be obtained by ANDing the RU IP address with the special mask. These condensed network IP addresses become the pointers to the memory locations where the TEI information should be stored. In order to distinguish between these two address spaces, all the routes for subnet size of 16 is placed after the entries for subnet size of 8 if the subnet size 16 is supported. In this case, a total of 1536 entries is created. First 1K entries are for subnet size of 8 and last 512 entries are for subnet size of 16. Each entry contains the TEI (the route) for the corresponding network. This requires only 1536 bytes of memory if TEI is one byte.

Once the routing table is created, the base applies the special mask to the destination IP address of the incoming datagram to identify the pointer to the routing table. (The base first applies the mask 255.128.0.0 on the destination IP. If the result is 10.0.0.0, the portion of the routing table for the subnet size of 8 is used. Otherwise, the portion for the subnet size of 16 is used. On the other hand, the base can check the first bit of the second byte, in the network byte order; if the bit is zero, the subnet type is the size of 8, otherwise it is 16. This check is needed only when the subnet size of 16 is supported.) Subsequently, the route entry is allocated by offsetting directly into the table based on the derived pointer.

Numbering Plan. The unassigned global IP addresses of the worldwide Internet are depleting quickly due to the widespread of the -Internet services. Given the potential number of addresses required for HSD service, it is very difficult to share the address space with the existing IP users, not to mention getting the addresses from the worldwide public Internet address space. The RFC-1918 private address space is utilized in the embodiment described.

In RFC-1918, the hosts needing IP address are classified into three categories: (1) Hosts that do not require access to hosts in other enterprises or the Internet at large; hosts within this category may use IP addresses that are unambiguous within an enterprise, but may be ambiguous between enterprises. (2) Hosts that need access to a limited set of outside services (e.g., E-mail, FTP netnews, remote login) which can be handled by mediating gateways (e.g., application layer gateways). For many hosts in this category an unrestricted external access (provided via IP connectivity) may be unnecessary and even undesirable for privacy/security reasons. Just like hosts within the first category, such hosts may use IP addresses that are unambiguous within an enterprise, but may be ambiguous between enterprises. (3) Hosts that need network layer access outside the enterprise (provided via IP connectivity); hosts in the last category require IP addresses that are globally unambiguous.

The RFC refers to the hosts in the first and second categories as private and the hosts in the third category as public. A set of address space is reserved for private hosts and is called private IP addresses. The remainder of the IP address space continues to be used for the public hosts (category 3 hosts). The HSD hosts including the HLAN network devices (PC, EPBS, etc.) and infrastructure hosts fall under category 2 in that the hosts have access to the public Internet by accessing the tunnel gateway provided by the ISP of choice. When not accessing the Internet, the PC traffic is mostly confined to within the HLAN, such as printing and file sharing. By using the private address space, a numbering structure may be employed without any coordination with IANA (Internet Assigned Number Authority) or an Internet registry. The address space can also be used repeatedly by many FWS Local Serving Areas (LSA). (From the IP number planning point of view, the definition of an LSA is a region where the addresses are unique. This implies that HSD users can have direct IP connectivity if they are in the same LSA. When FWS deploys multiple LSAs, users from different LSAs require the help of a proxy to have IP connectivity. From the Operations Support System (OSS) point of view, an area covers up to 360 bases. An LSA may consist of up to two OSS areas.) Addresses within this private address space are unique within the area, or the set of areas which choose to cooperate over this space so they may communicate with each other in their own private Internet. The latter case is applicable when a number of areas can be merged into one super area to serve one major metropolitan area. Private hosts can communicate with all other hosts inside the area. However, they cannot have IP connectivity to any host outside the area including other private areas reusing the same private space and the public Internet. While not having external (outside of the area) IP connectivity, private hosts can still have access to the external services via mediating gateways (e.g., proxy or tunnel server).

The numbering plan calls for using Net 10 address space for two types of the private network: the lower Class A 10 network address for the user space, and the top Class A address (10.255.254.0/23) for the infrastructure space. See FIG. 14 which shows an architecture 1400 that includes DSN 508 of FIG. 5. The following description relates to the lower Class A address. The first step is to make use of RFC 1918 Class A address range, 10.0.0.0 through 10.223.255.255.

This address space is used for every HLAN network device including the RU of the HLAN. The entire address space is subnetted into user HLAN subnets with size of eight addresses each. To use the Class A effectively, what is needed is the use of a routing protocol that allows a break up of the Class A into smaller sized sub-networks. The routing protocol that is preferred is the OSPF. It supports the supernetting and partitioning of the address space (a technology called VLSM, Variable Length Subnet Mask) and provides support for a two-level geographic routing hierarchy. OSPF is supported by the major router vendors and is currently in use in many networks, including the WorldNet. The OSPF is used only between the access routers if there are more than one router inside a DSN.

Allocation Policy. To keep routing tables from getting huge, it is advantageous to ensure that addresses are allocated to an OSPF area that can be aggregated for advertisement to other areas. This can only be done if they are contiguous. This also helps in simplifying the static route provisioning on the router. There may be no need to create other OSPF areas than the area zero, but at least the static routes to other routers within area zero is advertised. To ensure the subnets are contiguous, the numbering plan utilizes a fixed allocation of the addresses per base. Each router is given an aggregated space in the unit of number of bases. The first number specifies the administrative limit on the number of HSD subscribers one base can have. The second number specifies the maximum number of bases that are connected to one access router. Initially, from the IP numbering point of view, these two numbers are set to 2K HSD subscribers per base and 512 bases per router respectively. In reality, there may be more than one router used to serve these 512 bases; but from the IP Numbering point of view, the total number of bases within one area (LSA) cannot exceed 512. This means that for every LSA deployment, first 2K HLAN subnets from the Class A address space is reserved for the first base connecting to the first Access Router; the next 2K HLAN subnet is reserved for the second base connecting to the same router; and so on. All the subsequent introductions of a base are assigned the address space from the Net 10 subnet cluster until the limit of bases within an area is reached. (The administrative limit is 512 bases per LSA, but the Operations Support System (OSS) limit is 360 bases per LSA.)

Table 3 below depicts this plan, assuming 256 base connections but only 180 bases are connected per router to support one OSS area. (A continuation is provided later in Table 4.)

TABLE 3
Class A Addresses Allocation Map.

| Access Router (256 Bases) | | Base (2K HLANs) | | Home LAN (8 IPs) | |
|---|---|---|---|---|---|
| Net IP | Net Mask | Net IP | Net Mask | Net IP | Net Mask |
| 10.0.0.0 | 255.192.0.0 | 10.0.0.0 | 255.255.192.0 | Home 1: 10.0.0.0 | 255.255.255.248 |
| (First | | (Base 1) | | Home 2K: 10.0.63.248 | 255.255.255.248 |
| Router) | | 10.0.64.0 | 255.255.192.0 | H1: 10.0.64.0 | 255.255.255.248 |
| | | (Base 3) | | H2K: 10.0.127.248 | 255.255.255.248 |
| | | 10.44.192.0 | 255.255.192.0 | H1: 10.44.192.0 | 255.255.255.248 |
| | | (Base 359) | | H2K: 10.44.255.248 | 255.255.255.248 |
| 10.64.0.0 | 255.192.0.0 | 10.64.0.0 | 255.255.192.0 | H1: 10.64.0.0 | 255.255.255.248 |
| (Second | | (Base 2) | | H2K: 10.64.63.248 | 255.255.255.248 |
| Router) | | 10.64.64.0 | 255.255.192.0 | H1: 10.64.64.0 | 255.255.255.248 |
| | | (Base 4) | | H2K: 10.64.127.248 | 255.255.255.248 |
| | | 10.108.192.0 | 255.255.192.0 | H1: 10.108.192.0 | 255.255.255.248 |
| | | (Base 360) | | H2K: 10.108.255.248 | 255.255.255.248 |

The first router, with the administrative capacity of 256 bases, spans the address space from 10.0.0.0 to 10.63.255.255. Therefore the router only has to advertise the route 10.0.0.0/10 to other routers. The second router has the space from 10.64.0.0 to 10.127.255.255 can also advertise one route, 10.64.0.0/10, to other routers. With this arrangement, using only half of the Net 10 can already support the 360 base limit set by the OSS addressing scheme. This leaves the other half of the address available for numbering another area to form a super autonomous area, supporting upwards to 720 bases, or to be available to number the HLANs with a subnet size of 16 within the same area.

Super Area. In a service deployment area where the expected number of bases exceeds 360, the HSD numbering plan recommends the use of the remaining first half and some part of the second half of the Net 10 address space to support another 360 bases. By exhausting the first half of the Net 10 space (ends in the HLAN subnet of 10.127.255.248), a total of 512 bases can be supported. By using the address space from 10.128.0.0 to 191.255.255, 256 more or a total of 768 bases can be supported. (This is valid only if the second half of the Net10 is also used for the standard HLAN subnet of eight. If the second half of the address is used for subnet size of 16, the number of bases that can be supported will be limited to 360.) This is enough to cover the support of merging two OSS OSPF areas (720 bases) in the same LSA. Consequently, in anticipating the expansion of any LSA, the assignment of the OSS OSPF areas for each rollout should not be continuous. This way, it leaves the OSS address space available to assign up to two contiguous OSS OSPF areas to one LSA where more than 360 base are needed. In an LSA where the expanded HLAN subnet scheme (subnet 16) is used and there is a need to grow beyond 360 bases to support more subscribers, a second LSA with address reuse can be added to the same market area. These two areas form two independent LSAs with two non-aggregated OSS OSPF areas to serve the same market. The subscribers in different ISAs but within the same Market cannot communicate with each other without the help of proxy gateway or via the public Internet.

In Table 4, the usage of the remaining half and the second half of the Net 10 address space in a super area is shown. This table is a continuation of Table 3 above.

TABLE 4
Class A Address Allocation Map - Extended Table for Super Area

| Access Router (256 Bases) | | Base (2K HLANs) | | Home LAN (8 IPs) | |
|---|---|---|---|---|---|
| Net IP | Net Mask | Net IP | Net Mask | Net IP | Net Mask |
| 10.0.0.0 | 255.192.0.0 | 10.45.0.0 | 255.255.192.0 | Home 1: 10.45.0.0 | 255.255.255.248 |
| (First Router. | | (Base 361) | | Home 2K: 10.45.63.248 | 255.255.255.248 |
| Continued | | 10.45.64.0 | 255.255.192.0 | H1: 10.45.64.0 | 255.255.255.248 |
| from Table 3) | | (Base 363) | | H2K: 10.45.127.248 | 255.255.255.248 |
| | | 10.63.192.0 | 255.255.192.0 | H1: 10.63.192.0 | 255.255.255.248 |
| | | (Base 511) | | H2K: 10.63.255.248 | 255.255.255.248 |
| 10.64.0.0 | 255.192.0.0 | 10.109.0.0 | 255.255.192.0 | H1: 10.109.0.0 | 255.255.255.248 |
| (Second | | (Base 1) | | H2K: 10.109.63.248 | 255.255.255.248 |
| Router. | | 10.127.192.0 | 255.255.192.0. | H1: 10.127.192.0 | 255.255.255.248 |
| Continued | | (Base 512 | | H2K: 10.127.255.248 | 255.255.255.248 |
| from | | | | | |
| Table 3) | | | | | |
| 10.128.0.0 | 255.224.0.0 | 10.128.0.0 | 255.255.192.0 | Home: 10.128.0.0 | 255.255.255.248 |
| (Third | | (Base 513) | | Home 2K: 10.128.63.248 | 255.255.255.248 |
| Router) | | 10.128.64.0 | 255.255.192.0 | H1: 10.128.64.0 | 255.255.255.248 |
| | | (Base 515) | | H2K: 10.128.127.248 | 255.255.255.248 |
| | | 10.159.192.0 | 255.255.192.0 | H1: 10.159.192.0 | 255.255.255.248 |
| | | (Base 767) | | H2K: 10.159.255.248 | 255.255.255.248 |
| 10.160.0.0 | 255.224.0.0 | 10.160.0.0 | 255.255.192.0 | H1: 10.160.0.0 | 255.255.255.248 |
| (Fourth | | (Base 514) | | H2K: 10.160.63.248 | 255.255.255.248 |
| Router) | | 10.191.192.0 | 255.255.192.0 | H1: 10.191.192.0 | 255.255.255.248 |
| | | (Base 768) | | H2K: 10.191.255.248 | 255.255.255.248 |

Based on this plan, within a super area the maximal number of HLANs with the subnet size of eight that can be supported is 1.5 million. In this case, there are four aggregated routes advertised by the routers—10.0.0.0/10, 10.64.0.0/10, 10.128.0.0/11, and 10.160.0.0/11. Although four routers were operated in the redundant mode for the entire LSA to support 720 bases, the first two routers can be used for connecting to the bases beyond 512nd base as long as the routers have enough slots to put more DS3 cards and can keep up with the performance. If only two routers are used to handle all the base connections without using the third and the fourth routers, these two routers must advertise the last two aggregated routes since no further route aggregation is possible.

HLAN with Subnet Size of 16. As mentioned previously, the second half of the class A address space from 10.128.0.0 to 10.223.255.255 can also be used for the expanded HLAN subnets, each with 16 addresses. In order to ensure proper route aggregation, the numbering plan specifies a fixed allocation of the addresses per base. There are two numbers for determining the address allocation. The first number specifies the administrative limit on the number of HSD subscribers with the expanded subnet (size of 16 addresses) per base. The second number specifies the maximal number of bases that are connected to one access router. Since the second number follows the one used in the standard HLAN subnet address allocation scheme, it is needed to determine only the first number. Since the size of the expanded subnet is twice that of the standard subnet, in order to support the same number of the bases supported in the case of the standard subnets, the number of the expanded subnets (size of 16 IP addresses) per base is half of that supported with a subnet size of eight. This gives rise to 1K expanded subnets per base. Furthermore, if the expanded subnet scheme is adopted, since support is provided for 360 bases in one LSA, the address space from 10.128.0.0 to 10.223.255.255 will be enough. (The space can support 384 bases.) This allows the use of the address space from 10.224.0.0 to 10.255.255.255 for other purposes, e.g., HSD infrastructure routers and servers.

Table 5 shows the allocation of the second half of the Net 10 in the same redundancy mode for supporting the expanded subnets.

TABLE 5
Expand User Address Space Allocation Map

| Access Router (256 Bases) | | Base (2K EHLANs) | | Expanded Home LAN (1.6 IPs) | |
|---|---|---|---|---|---|
| Net IP | Net Mask | Net IP | Net Mask | Net IP | Net Mask |
| 10.128.0.0 | 255.240.0.0 | 10.128.0.0 | 255.255.192.0 | Home 1: 10.128.0.0 | 255.255.255.240 |
| (First Router. | | (Base 1) | | Home 1K: 10.128.63.240 | 255.255.255.240 |
| | | 10.128.64.0 | 255.255.192.0 | H1: 10.128.64.0 | 255.255.255.240 |
| | | (Base 3) | | H1K: 10.128.127.240 | 255.255.255.240 |
| | | 10.143.192.0 | 255.255.192.0 | H1: 10.143.192.0 | 255.255.255.240 |
| | | (Base 127) | | H1K: 10.143.255.240 | 255.255.255.240 |
| 10.144.0.0 | 255.240.0.0 | 10.144.0.0 | 255.255.192.0 | H1: 10.144.0.0 | 255.255.255.240 |
| (First Router) | | (Base 129) | | H1K: 10.144.63.240 | 255.255.255.240 |
| | | 10.159.192.0 | 255.255.192.0 | H1: 10.159.192.0 | 255.255.255.240 |
| | | (Base 255) | | H1K: 10.159.255.240 | 255.255.255.240 |
| 10.160.0.0 | 255.240.0.0 | 10.160.0.0 | 255.255.192.0 | H1: 10.160.0.0 | 255.255.255.240 |
| (First Router) | | (Base 257) | | H1K: 10.160.63.240 | 255.255.255.240 |
| | | 10.175.192.0 | 255.255.192.0 | H1: 10.175.192.0 | 255.255.255.240 |
| | | (Base 383) | | H1K: 10.175.255.240 | 255.255.255.240 |
| 10.176.0.0 | 255.240.0.0 | 10.176.0.0 | 255.255.192.0 | Home 1: 10.176.0.0 | 255.255.255.240 |
| (Second | | (Base 2) | | Home 1K: 10.176.63.240 | 255.255.255.240 |
| Router) | | 10.176.64.0 | 255.255.192.0 | H1: 10.176.64.0 | 255.255.255.240 |
| | | (Base 4) | | H2K: 10.176.127.240 | 255.255.255.240 |
| | | 10.191.192.0 | 255.255.192.0 | H1: 10.191.192.40 | 255.255.255.240 |
| | | (Base 128) | | H1K: 10.191.255.240 | 255.255.255.240 |
| 10.192.0.0 | 255.240.0.0 | 10.192.0.0 | 255.255.192.0 | H1: 10.192.0.0 | 255.255.255.240 |
| (Second | | (Base 130) | | H1K: 10.192.63.240 | 255.255.255.240 |
| Router) | | 10.207.192.0 | 255.255.192.0 | H1: 10.207.192.0 | 255.255.255.240 |
| | | (Base 256) | | H1K: 10.207.255.240 | 255.255.255.240 |
| 10.208.0.0 | 255.240.0.0 | 10.258.0.0 | 255.255.192.0 | H1: 10.208.0.0 | 255.255.255.240 |
| (Second | | (Base 258) | | H1K: 10.208.63.240 | 255.255.255.240 |
| Router) | | 10.223.192.0 | 255.255.192.0 | H1: 10.223.192.0 | 255.255.255.240 |
| | | (Base 384) | | H1K: 10.223.255.240 | 255.255.255.240 |

Each router now advertises three extra routes each with the mask of 255.240.0.0. By using the second half of the Net 10 on the expanded subnets, the LSA with 360 bases in that area is limited to supporting 737,280 homes. Out of which, up to 368,640 homes can be the Expanded HLANs. In contrast, when applying the space for a super area, one LSA supports 1.5 M standard HLANs with 720 bases in that area.

The following description relates to the use of Upper Class A addresses. The assignment of the address space for the DSNs, including the HSD extension of the ISP routers and servers, should be such that, no matter how the user address space is reused, the servers and routers should be manageable directly without going over any gateway or proxy. This means that, from the OSS point of view, the address space for the DSNs, or infrastructure, should not be reused and should be globally unique no matter how the user space is reused. On the other hand, the address assignment of the HSD infrastructure should be independent of the OSS address scheme such that the provisioning of the HSD network elements can be repeated from area to area. This implies the reuse of the address space even for the HSD infrastructure. In order to satisfy both goals, and also for added security, the numbering plan specifies that each OSS manageable network element on the DSN have two interfaces, one with the unique OSS IP address (172.x.x.x) and the other one with the HSD repeatable IP address from the upper Net 10 address space. All the OSS interfaces are on LAN segments separated physically from the interfaces that HSD user traffic flow through. This allows a better access control between the HSD user network and the OSS network.

From the OSS network point of view, the HSD network elements are always globally unique and are manageable directly without the help of a gateway or proxy. Since, according to the OSS Numbering Plan, there are two Class C worth of the unique address space reserved for the HSD within an OSS area, the numbering plan specifies to supemet two private Class Cs, 10,255.254.0/23, a total of 510 addresses, for the HSD Infrastructure and the HSD extension of the ISP infrastructure if needed.

HSD Infrastructure. Depending on the geographic areas where the FWS is deployed, there are two types of the access network architectures. In a densely populated area, it is possible to have a single DSN connecting to all the bases in that area with many Access Routers, since the backhaul from the base to the DSN is moderately short. In a sparsely populated area, on the other hand, a network needs to be setup such that traffic can be concentrated from remote sites on a few high speed links back to the DSN. It reduces the cost on hauling user traffic to the Access Router from every base if the bases are far from the DSN. The address space allocated for the DSN covers all the routers and the servers under the auspices of the DSN, including the remote access routers that concentrate the remote bases back to the main Access Router (AR) when the service is deployed in a sparsely populated area. The numbering plan specifies the use of 10.255.254.0/23 for the HSD infrastructure within an area. The allocation of the HSD infrastructure space should start from the low end of the space for the router and the high end for the servers. If further subnetting of the space is needed to support remote router complex in a sparsely populated area, the DSN should start from the lower numbered subnet, and the remote complex should start from the higher numbered subnet.

ISP Address Space. A subnet of address space 10.255.254.0/23 may be reserved for ISP service complex that contains servers directly accessible by the HSD subscribers. Those servers may include the PPTP/ tunnel server and HTTP servers (needed for subscription or other services accessible by privately addressed clients before a tunnel is established.) This address space should be subnetted in order to accommodate connections to different ISPs. With subnet sizes of 16 and 32 addresses (14 and 30 usable addresses), this addressing scheme can support eight small ISPs and four large ISP per DSN, that is, a total of 12 ISP choices for the subscribers within the areas served by the same DSN. Table 6 shows this arrangement.

TABLE 6
Class C ISP Addresses Space Allocation Map

HSD Extension on the ISP Complex

| ISP Net IP | Net Mask |
|---|---|
| (Small ISP 1) 10.255.255.0 | 255.255.255.240 |
| (Small ISP 2) 10.255.255.16 | 255.255.255.240 |
| (Small ISP 8) 10.255.255.112 | 255.255.255.240 |
| (Large ISP 1) 10.255.255.128 | 255.255.255.224 |
| (Large ISP 2) 10.255.255.160 | 255.255.255.224 |
| (Large ISP 4) 10.255.255.224 | 255.255.255.224 |

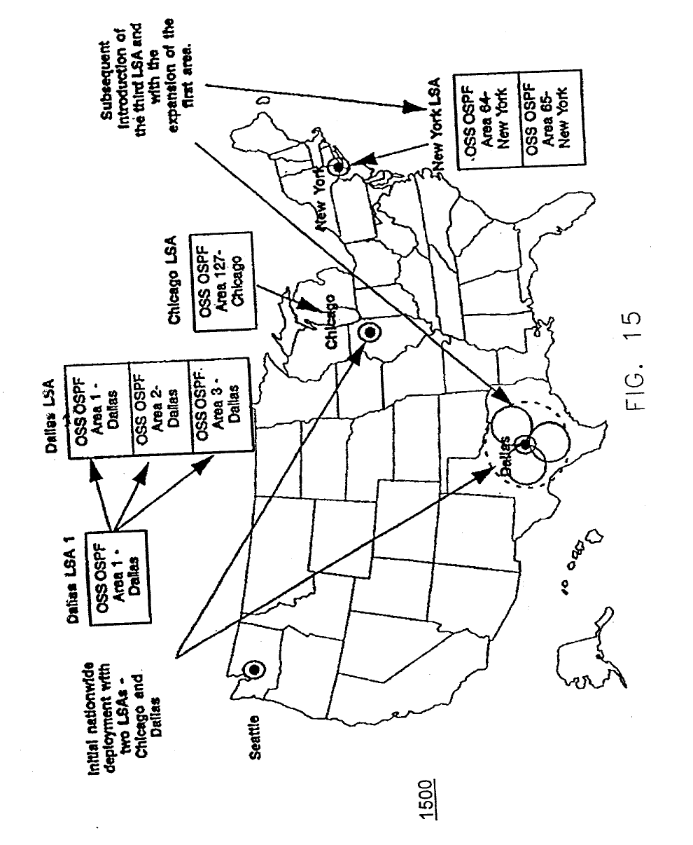

Migration and Evolution Architecture. What is discussed next is a numbering strategy to support multi-LSA in a nation-wide service deployment scenario. FIG. 15 shows an example of a deployment map 1500. Here, two LSAs are introduced for the first two scheduled rollouts. Each LSA uses the Net 10 address space and is assigned an OSS OSPF area, one is assigned as Area 1 and the other is Area 127. As the demand grows, the FWS introduces the third LSA meanwhile expanding the first LSA. In the this case, the third LSA gets the OSS OSPF area assignment from the middle section of the areas. The individual LSA can further grow by being assigned with more OSPF areas, thus adding more bases to the LSA, until the Net 10 address space in that ISA reaches the administrative limit. Similarly, new LSAs will also be introduced as new market areas are found. The new LSA can be introduced, or the existing LSA can be expanded, until all the OSS OSPF areas are assigned, based on the OSS numbering plan. When the numbering plan reaches this limit, the entire nation will have 63 LSAs, each with two OSS OSPF areas supporting 720 bases, with a total of 93 million subscribers. Once the limit is reached, the migration from the current IPv4 addressing scheme (four-byte IP address) to the IPv6 addressing scheme (16-byte IP address) should take place. In this case, a range of public IPv6 address space can be allocated so that any inconveniences introduced by using the private address are removed.

Described above are methods and apparatus for use in reducing traffic over a communication link used by a computer network. One method includes the steps of monitoring, at a gateway, communications involving address assignment between an address-assigning computer device and one or more computer devices; storing, at the gateway, at least one computer device identifier corresponding to at least one computer device that was assigned an address by the address-assigning computer device; receiving, at the gateway, traffic associated with a first computer device of the one or more computer devices; identifying, at the gateway using the at least one computer device identifier, that the first computer device is one that was assigned an address by the address-assigning computer device; transmitting, from the gateway over the communication link, traffic associated with the first computer device based on identifying that it was assigned an address by the address-assigning computer device; receiving, at the gateway, traffic associated with a second computer device of the one or more computer devices; failing to identify, at the gateway using the at least one computer device identifier, that the second computer device is one that was assigned an address by the address-assigning computer device; and inhibiting transmission, from the gateway over the communication link, traffic associated with the second computer device based on failing to identify that it was assigned an address by the address-assigning computer device.

Other methods and apparatus for controlling the use of resources in a computer network are also described. A preferred method here involves the steps of receiving, at an address-assigning computer device, an address request from a computer device of a local computer network; reading, at the address-assigning computer device, subscription data associated with the computer device, the subscription data including data indicative of a maximum allowable number of addresses for simultaneous use by the local computer network; and determining, at the address-assigning computer device, whether to assign an address to the computer device based on the maximum allowable number of addresses and an actual number of addresses simultaneously assigned to the local computer network. This method may include the further steps of assigning an address to the computer device if it is determined that the actual number of addresses is less than the maximum allowable number of addresses, and/or declining to assign an address to the computer device if it is determined that the actual number of addresses is equal to the maximum allowable number of addresses.

Finally, a computer network of another aspect of the present invention includes a plurality of gateway devices and a service-providing network including one or more servers. Each gateway device is coupled to one or more computer devices associated with the device. The plurality of gateway devices and the service-providing network are operative to communicate over a communication link. Each gateway device is operative for receiving traffic from a computer device; masking a destination address of the traffic with a mask which allows addressing to the service providing network but disallows direct addressing to computer devices associated with the plurality of gateway devices; and transmitting, over the communication link, traffic addressed to the service providing network. This method includes the further steps of not transmitting, over the communication link, traffic addressed to the computer devices associated with the plurality of gateway devices. Preferably, the computer network is part of a fixed wireless system which includes a wireless base unit coupled to the service providing network and to the plurality of gateway devices via a wireless communication link.

It should be readily apparent and understood that the foregoing description is only illustrative of the invention and, in particular, provides preferred embodiments thereof. Various alternatives and modifications can be devised by those skilled in the art without departing from the true spirit and scope of the invention. Accordingly, the present invention is intended to embrace all such alternatives, modifications, and variations which fall within the scope of the appended claims.

What is claimed is:

1. A method for use in reducing traffic over a communication link used by a computer network, the computer network including one or more computer devices coupled to the communication link by a gateway, the method comprising:
monitoring communications on the communication link involving address assignment to one or more computer devices on a computer network;
storing at least one computer device identifier corresponding to at least one computer device having an assigned address received in a communication on the communication link;
receiving, at the gateway, traffic from the computer network that is associated with a computer device of the one or more computer devices;
determining at the gateway using the at least one computer device identifier, whether the computer device has an assigned address; and
if the computer device does not have an assigned address received on a communication on the communication link, blocking the traffic from the communication link;
otherwise, transmitting the traffic through the gateway to the communication link based upon an assigned address for the computer device received on the communication link.

2. The method according to claim 1, wherein storing the at least one computer device identifier further comprises:
storing the assigned address in association with the at least one computer device identifier.

3. The method according to claim 1, wherein storing the at least one computer device identifier further comprises:
storing at least one physical address corresponding to the at least one computer device.

4. The method according to claim 1, wherein the communication link comprises a wireless communication link.

5. The method according to claim 1, wherein the communication link comprises a wireless communication link of a fixed wireless system.

6. The method according to claim 1, wherein the gateway device comprises a wireless transceiver unit.

7. The method according to claim 1, wherein the address-assigning computer device comprises a dynamic host configuration protocol (DHCP)-type server.

8. A computer network, comprising:
a service-providing network including an address-assigning computer device;
a gateway device connected to the service-providing network for:
monitoring communications involving address assignment between the address-assigning computer device and one or more computer devices;
storing at least one computer device identifier corresponding to at least one computer device that was assigned an address by the address-assigning computer device;
receiving traffic from a computer device of the one or more computer devices;
using the at least one computer device identifier, determining whether the computer device is one that was assigned an address by the address-assigning computer device; and
if the computer device does not have an assigned address received on a communication on the communication link, blocking the traffic from the communication link;
otherwise, transmitting the traffic through the gateway to the communication link based upon an assigned address for the computer device received on the communication link.

9. The computer network according to claim 8, further comprising:
the gateway device further for:
storing the assigned address in association with the at least one computer device identifier.

10. The computer network according to claim 8, further comprising:
the gateway device being further operative for:
storing the at least one physical address corresponding to the at least one computer device.

11. The computer network according to claim 8, wherein the communication link comprises a wireless communication link.

12. The computer network according to claim 8, wherein the gateway device comprises a wireless transceiver unit.

13. The computer network according to claim 8, wherein the address-assigning computer device comprises a dynamic host configuration protocol (DHCP)-type server.

16. A fixed wireless system, comprising:
a wireless transceiver unit;
the wireless transceiver unit having an input for coupling to a plurality of computer devices;
a wireless base unit;
the wireless base unit and transceiver unit operative to communicate over a wireless communication link;
an address-assigning computer device coupled to the wireless base unit;
the wireless transceiver unit operative to transmit address requests for the computer devices to the address-assigning computer device;
the wireless transceiver unit operative to transmit, over the wireless communication link, traffic from a computer device that was assigned an address by the addressing assigning computer device; and
the wireless transceiver unit operative to inhibit transmission of traffic over the wireless communication link from one or more other computer devices that were not assigned an address by the address-assigning computer device.

17. The fixed wireless system according to claim 16, further comprising:
the wireless transceiver unit operative to store a computer device identifier to identify the traffic from the computer device that was assigned the address by the address-assigning computer device.

18. The fixed wireless system according to claim 16, further comprising:
the wireless transceiver unit operative to store the address to identify the traffic from the computer device that was assigned the address by the address-assigning computer device.

19. The fixed wireless system according to claim 16, further comprising:
wherein the address-assigning computer device comprises a private address-assigning computer device.

20. The fixed wireless system according to claim 16, wherein the computer device comprises a first computer device and the address comprises a first address, the fixed wireless system further comprising:
the wireless transceiver unit operative to transmit, over the wireless communication link, traffic from a second computer device that was assigned a second address by the addressing assigning computer device.

21. A method for controlling the use of resources in a computer network, the method comprising:
receiving, at an address-assigning computer device, an address request from a computer device of a local computer network;
reading, at the address-assigning computer device, subscription data associated with the computer device, the subscription data including -data indicative of a maximum allowable number of addresses for simultaneous use by the local computer network; and
determining, at the address-assigning computer device, whether to assign an address to the computer device based on the maximum allowable number of addresses and an actual number of addresses simultaneously assigned to the local computer network.

22. The method according to claim 21, further comprising:
assigning an address to the computer device if it is determined that the actual number of addresses is less than the maximum allowable number of addresses.

23. The method according to claim 21, further comprising:
declining to assign an address to the computer device if it is determined that the actual number of addresses is equal to the maximum allowable number of addresses.

24. The method according to claim 21, wherein the local computer network comprises a first local computer network, the computer device comprises a first computer device, and the subscription data comprises first subscription data, the method further comprising:
receiving, at the address-assigning computer device, an address request from a second computer device of a second local computer network;
reading, at the address-assigning computer device, second subscription data associated with the second local computer network, the second subscription data including data indicative of a maximum allowable number of addresses for simultaneous use by the second local computer network; and
determining, at the address-assigning computer device, whether to assign an address to the second computer device based on the maximum allowable number of addresses and an actual number of addresses simultaneously assigned to the second local computer network.

25. The method according to claim 21, wherein the address-assigning computer device comprises a dynamic host configuration protocol (DHCP)-type server.

26. The method according to claim 22, wherein the computer network further comprises a gateway coupled between the local computer network and the address-assigning computer device over a communication link, the method further comprising:
monitoring, at the gateway, communications involving the address assignment between the address-assigning computer device and the computer device;
storing, at the gateway, a computer device identifier corresponding to the computer device that was assigned the address by the address-assigning computer device;
receiving, at the gateway, traffic from the computer device;
identifying, at the gateway using the computer device identifier, that the computer device is one that was assigned an address by the address-assigning computer device; and transmitting, from the gateway, traffic from the computer device based on identifying that it was assigned an address by the address-assigning computer device.

27. The method according to claim 26, further comprising:
receiving, at the gateway, traffic from another computer device in the local computer network;
failing to identify, at the gateway, that the other computer device is one that was assigned an address by the address-assigning computer device; and
inhibiting transmission, from the gateway, traffic from the other computer device based on failing to identify that it was assigned an address by the address-assigning computer device.

28. An address-assigning computer device for controlling use of resources in a computer network, the address-assigning computer device operative to receive an address request from a computer device of a local computer network; read subscription data associated with the local computer network, where the subscription data includes data indicative of a maximum allowable number of addresses for simultaneous use by the local computer network; and determine whether to assign an address to the computer device based on the maximum allowable number of addresses and an actual number of addresses simultaneously assigned to the local computer network.

29. The address-assigning computer device according to claim 28, wherein the address-assigning computer device is further operative to assign an address to the computer device if it is determined that the actual number of addresses is less than the maximum allowable number of addresses.

30. The address-assigning computer device according to claim 28, wherein the address-assigning computer device is further operative to decline to assign an address to the computer device if it is determined that the actual number of addresses is equal to the maximum allowable number of addresses.

31. The address-assigning computer device according to claim 28, wherein the local computer network comprises a first local computer network, the computer device comprises a first computer device, and the subscription data comprises first subscription data, and wherein the address-assigning computer device is further operative to receive an address request from a second computer device of a second local computer network; read second subscription data associated with the second local computer network, where the second subscription data includes data indicative of a maximum allowable number of addresses for simultaneous use by the second local computer network; and determine whether to assign an address to the second computer device based on the maximum allowable number of addresses and an actual number of addresses simultaneously assigned to the second local computer network.

32. The address-assigning computer device according to claim 28, comprising a dynamic host configuration protocol (DHCP)-type server.

33. An address-assigning computer device for controlling use of resources in a computer network which involves a first local computer network and a second local computer network:
wherein the address-assigning computer device is operative to:
receive an address request from a first computer device of the first local computer network;
read first subscription data associated with the first local computer network, where the first subscription data includes data indicative of a maximum allowable number of addresses for simultaneous use by the first local computer network;
determine whether to assign an address to the first computer device based on the maximum allowable number of addresses and an actual number of addresses simultaneously assigned to the first local computer network;
wherein the address-assigning computer device is further operative to:
receive an address request from a second computer device of the second local computer network;
read second subscription data associated with the second local computer network, where the second subscription data includes data indicative of a maximum allowable number of addresses for simultaneous use by the second local computer network; and
determine whether to assign an address to the second computer device based on the maximum allowable number of addresses and an actual number of addresses simultaneously assigned to the second local computer network.

34. The address-assigning computer device according to claim 33, comprising a dynamic host configuration protocol (DHCP)-type server.

35. A computer network, comprising:
a plurality of gateway devices, each gateway device for coupling to one or more computer devices associated therewith;
a service-providing network including one or more servers;
the plurality of gateway devices and the service-providing network operative to communicate over a communication link;
each gateway device operative for:
receiving traffic from a computer device;
masking a destination address of the traffic with a mask which allows addressing to the service providing network but disallows direct addressing to computer devices associated with the plurality of gateway devices; and
transmitting, over the communication link, traffic addressed to the service providing network.

36. The computer network according to claim 35, further comprising:
the gateway device being further operative for:
not transmitting, over the communication link, traffic addressed to the computer devices coupled associated with the plurality of gateway devices.

37. The computer network according to claim 35, wherein the communication link comprises a wireless communication link.

38. The computer network according to claim 35, wherein the gateway device comprises a wireless transceiver unit.

39. The computer network according to claim 35, further comprising:
wherein each gateway device comprises a wireless transceiver unit; and
a wireless base unit coupled to the service providing network; and
the wireless base unit for facilitating a wireless communication link between the wireless base unit and the plurality of wireless transceiver units.

40. A method for use in facilitating communication in a computer network involving one or more computer devices coupled to a gateway, the method comprising:
monitoring, at the gateway, communications involving address assignment between an address-assigning computer device and a computer device; and
storing, at the gateway, an association between a physical address of the computer device and an address that was assigned to the computer device by the address-assigning computer device.

41. The method according to claim 40, further comprising:
receiving, at the gateway, traffic with the same address that was assigned to the computer device; and
sending, from the gateway, the traffic to the computer device using the stored association.

42. The method according to claim 40, further comprising:
identifying, from the communications involving the address assignment, the physical address and the assigned address.

43. The method according to claim 40, wherein the address that was assigned to the computer device comprises an IP address.

44. The method according to claim 40, wherein the physical address comprises a Medium Access Channel (MAC) address of the computer device.

45. The method according to claim 40, wherein the computer device comprises a personal computer (PC).

46. The method according to claim 40, wherein the gateway comprises a wireless transceiver and the one or more computer devices comprises personal computers (PCs).

47. The method according to claim 40, wherein the address-assigning computer device comprises a dynamic host configuration protocol (DHCP)-type server.
